(19) United States
(12) Patent Application Publication
(10) Pub. No.: US 2025/0008593 A1
(43) Pub. Date: Jan. 2, 2025

(54) MANAGING UNICAST, MULTICAST AND BROADCAST TRANSMISSIONS

(71) Applicant: GOOGLE LLC, Mountain View, CA (US)

(72) Inventor: Chih-Hsiang Wu, Taoyuan City (TW)

(21) Appl. No.: 18/699,888

(22) PCT Filed: Oct. 18, 2022
(86) PCT No.: PCT/US2022/046930

§ 371 Date: Apr. 9, 2024

Related U.S. Application Data
(60) Provisional application No. 63/270,367, filed on Oct. 21, 2021.

(51) Int. Cl. H04W 76/22; H04W 76/40

(52) U.S. Cl. CPC H04W 76/22; H04W 76/40

(57) ABSTRACT

A method for delivering data to User Equipments (UEs) is implemented in a node of a Radio Access Network (RAN), and includes receiving, from a network node, a packet including data that is to be delivered from a Core Network (CN) to one or more User Equipments (UEs); transmitting the packet to at least some of the one or more UEs via a broadcast transmission when the packet is received via a common downlink tunnel or via a first DL tunnel of a plurality of DL tunnels; and transmitting the packet to a particular UE of the one or more UEs via a unicast transmission when the packet is not received via the common downlink tunnel or is received via a second DL tunnel of the plurality of DL tunnels.

### FIELD OF THE DISCLOSURE

This disclosure relates to wireless communications and, more particularly, to enabling unicast, multicast and/or broadcast communications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (see 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul. When these network nodes support different radio access technologies (RATs), this type of connectivity is referred to as multi-radio dual connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed or disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in SC or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform a PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier in 5G NR, 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IoT) applications, V2X applications, and emergency messages related to public safety, for example.

5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface, while in PTM communications a RAN node transmits a single copy of each MBS data packet to multiple UEs over the radio interface. In some scenarios, however, it is unclear what configurations a base station should generate for UEs to receive an MBS data packet multicast and/or unicast by the base station.

### BRIEF DESCRIPTION OF THE DRAWINGS

FIG. 1A is a block diagram of an example system in which the techniques of this disclosure for managing transmission and reception of MBS information can be implemented;

FIG. 1B is a block diagram of an example base station in which a centralized unit (CU) and a distributed unit (DU) can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a base station;

FIG. 3 is a block diagram illustrating example tunnel architectures for MBS sessions and PDU sessions.

FIG. 4 is a block diagram illustrating example MRBs and DRBs which a distributed base station can configure for communicating multicast, broadcast, and/or unicast traffic with UEs.

FIGS. 5-6 are messaging diagrams of example scenarios in which a CN and a distributed base station configure resources for transmitting MBS data of one or more MBS sessions to multiple UEs.

FIGS. 7A-10 are flow diagrams of example methods for configuring configuration parameters for a DRB and a MRB, which can be implemented in a base station of FIG. 1A or in a DU of FIG. 1B.

### DETAILED DESCRIPTION OF THE DRAWINGS

Generally speaking, a RAN and/or a CN implement the techniques of this disclosure to manage transmission of multicast and/or broadcast services (MBS). A CN can request that a base station configure a common downlink (DL) tunnel via which the CN can transmit MBS data for an MBS session to the base station, for multiple UEs. In response to the request, the base station transmits a configuration of the common DL tunnel to the CN. The configuration can include transport-layer information such as an Internet Protocol (IP) address and a tunnel identifier (e.g., a Tunnel Endpoint Identifier (TEID)).

The base station can also configure one or more logical channels toward the UEs, and/or one or more MBS radio bearers (MRBs) associated with the MBS session, where there may be a one-to-one mapping between each logical channel and each MRB. After receiving MBS data for the MBS session via the common DL tunnel, the base station can transmit the MBS data via the one or more logical channels to one or more UEs that have joined the MBS session. In some implementations, the base station transmits MBS data to multiple UEs via a single logical channel. Further, if there are multiple quality-of-service (QoS) flows for the MBS session, a single logical channel may be associated with the multiple QoS flows, or there may be a one-to-one mapping between each QoS flow and each logical channel.

The CN can cause the base station to configure the common DL tunnel before or after a UE joins the MBS session. If additional UEs join the MBS session after the tunnel is configured, the CN can utilize the same common DL tunnel to transmit MBS data, for the multiple UEs, to the base station.

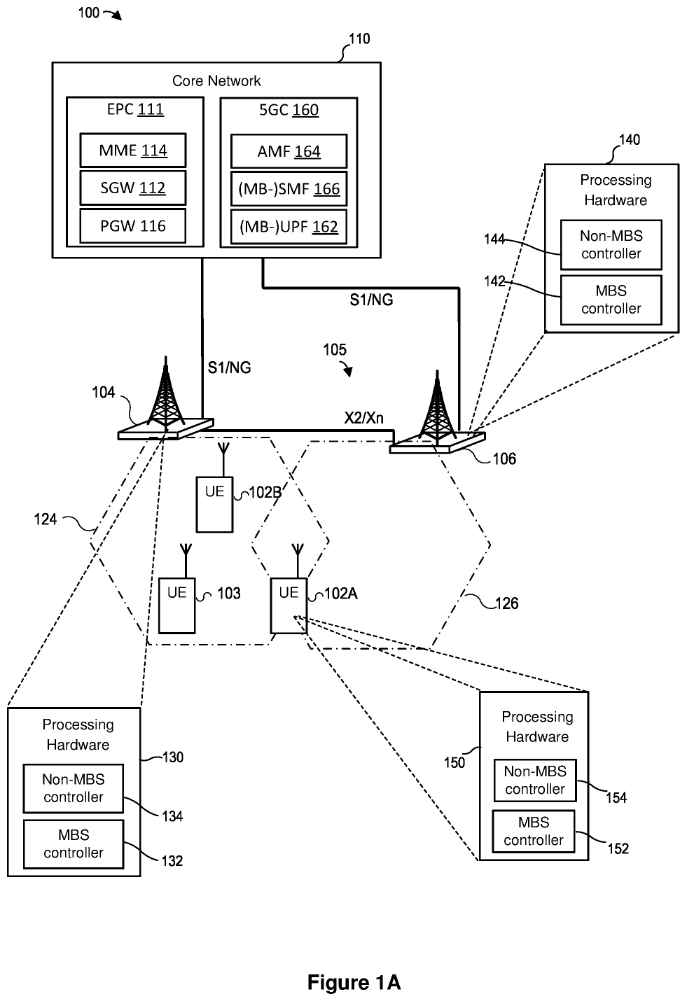

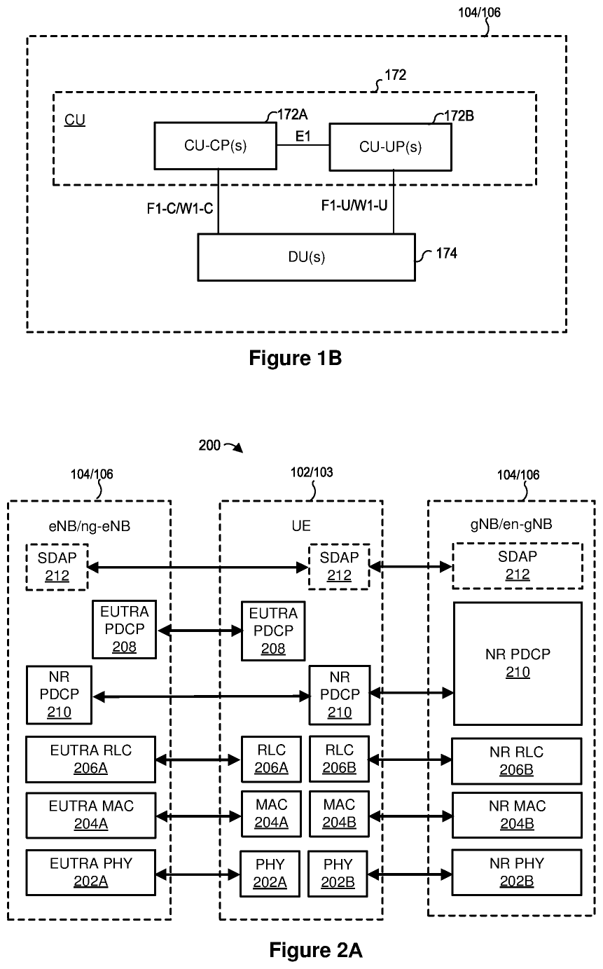

FIG. 1A depicts an example wireless communication system 100 in which techniques of this disclosure for managing transmission and reception of multicast and/or broadcast services (MBS) information can be implemented. The wireless communication system 100 includes user equipment (UEs) 102A, 102B, 103A, 103B, as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base station 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows the various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (NMRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit NBS data over unicast radio resources (i.e., the radio resources dedicated to the UE 102A) to the UE 102A via the MRB. In other scenarios, the base station (e.g., the MN or SN) can transmit NBS data over multicast radio resources (i.e., the radio resources common to the UE 102A and one or more other UEs), or a DL BWP of a cell from the base station to the UE 102A via the NMRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of NBS information received from the CN 110 or an edge server. For example, the NBS controller 132 can be configured to support radio resource control (RRC) configurations, procedures and messaging associated with NMBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an NBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an NBS controller 152 that is configured to manage or control reception of MBS information. For example, the UE NBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, the UE 102B may include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of any one or more of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

The description above can apply to the UEs 102B, 103A and 103B.

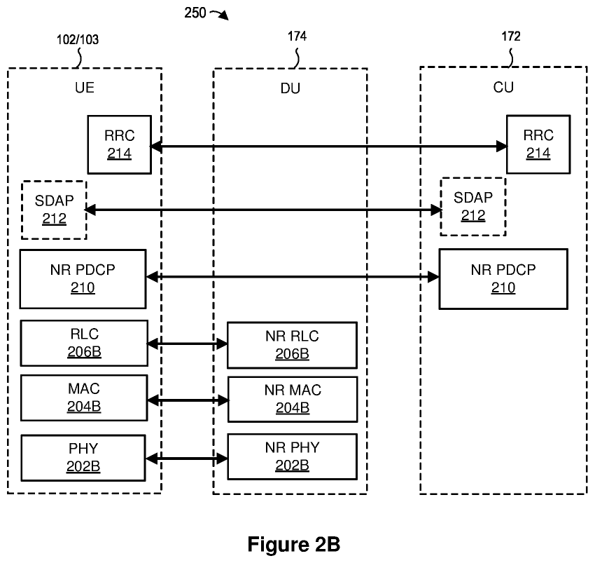

FIG. 2A illustrates, in a simplified manner, an example protocol stack 200 according to which a UE (e.g., UE 102A, 102B, 103A or 103B) can communicate with an eNB/ng-eNB or a gNB (e.g., one or more of the base stations 104, 106). In the example protocol stack 200, a PHY sublayer 202A of EUTRA provides transport channels to a EUTRA MAC sublayer 204A, which in turn provides logical channels to a EUTRA RLC sublayer 206A. The EUTRA RLC sublayer 206A in turn provides RLC channels to a EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE operates in EN-DC with the base station 104 operating as an MeNB and the base station 106 operating as an SgNB, the wireless communication system 100 can provide the UE with an MN-terminated bearer that uses EUTRA PDCP sublayer 208, or an MN-terminated bearer that uses NR PDCP sublayer 210. The wireless communication system 100 in various scenarios can also provide the UE with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts MBS data packets via one or more MBS radio bearers (MRB(s)), and in turn the UE (e.g., the UE 102, 103) receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE uses PHY sublayer 202, MAC sublayer 204, and RLC sublayer 206 to receive the MBS data packets. In such implementations, the base station and the UE may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE uses PHY sublayer 202, MAC sublayer 204, RLC sublayer 206 and PDCP sublayer 208 to receive the MBS data packets. In such implementations, the base station and the UE may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 which the UE can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

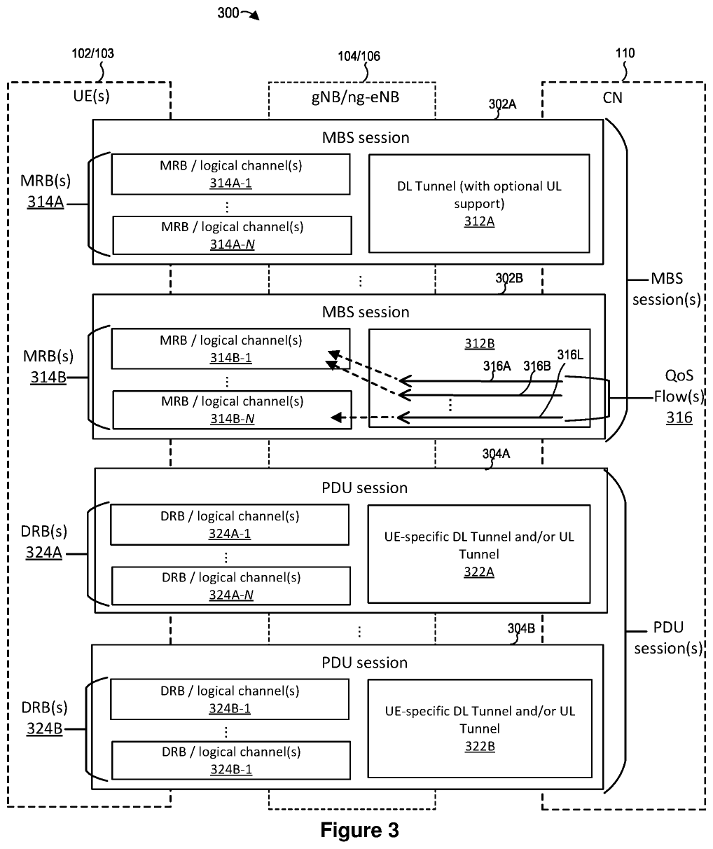

Referring to FIG. 3, an MBS session 302A can include a tunnel 312A with endpoints at the CN 110 and the base station 104/106. The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, CN 110 and the base station 104/106 use the tunnel 312A for downlink as well as for uplink (UL) MBS traffic to support, for example, commands or service requests from the UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and a GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . , 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QoS) flows, for each of the tunnels 312A, 312B, etc. For example, the MBS traffic on the tunnel 312B can include a set of flows 316 including QoS flows 316A, 316B, . . . , 316L. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific DL tunnel 322A corresponding to one or more DRBs 324A, such as a DRB 324A-1, 324A-2, . . . , 324-N. Each of the DRBs 324A can correspond to a respective logical channel, such as a Dedicated Traffic Channel (DTCH).

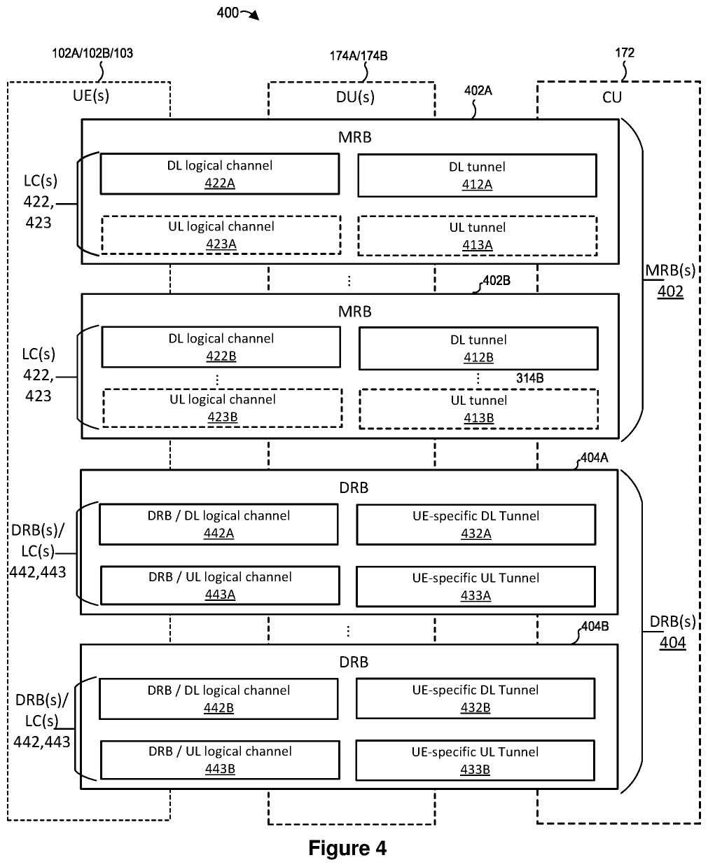

Now referring to FIG. 4, when the base station 104/106 is implemented in a distributed manner, the CU 172 and the DU 174A/174B can establish tunnels for downlink data and/or uplink data associated with an MRB or a DRB. The MRB 314A-1 discussed above can be implemented as an MRB 402A connecting the CU 172 to multiple UEs such as the UE 102A and 102B, for example. The MRB 402A can include a DL tunnel 412A connecting the CU 172 and the DU 174A/174B, and a DL logical channel 422A corresponding to the DL tunnel 412A. In particular, the DU 174A/174B can map downlink traffic received via the DL tunnel 412A to the DL logical channel 422A, which can be an MTCH or a DTCH, for example. The DL tunnel 412A can be a common DL tunnel via which the CU 172 transmits MBS data packets to multiple UEs. Alternatively, the DL tunnel 412A can be a UE-specific DL tunnel via which the CU 172 transmits MBS data packets to a particular UE.

Optionally, the MRB 402A also includes a UL tunnel 413A connecting the CU 172 and the DU 174A/174B, and a UL logical channel 423A corresponding to the UL tunnel 413A. The UL logical channel 423A can be a DTCH, for example. The DU 174A/174B can map uplink traffic received via the UL logical channel 423A to the UL tunnel 413A.

The tunnels 412A and 413A can operate at the transport layer or sublayer of the F1-U interface. As a more specific example, the CU 172 and the DU 174A/174B can utilize an F1-U for user-plane traffic, and the tunnels 412A and 413A can be associated with the GTP-U protocol layered over UDP/IP, where IP is layered over suitable data link and physical (PHY) layers. Further, the MRB(s) 402 and/or the DRB(s) 404 in at least some of the cases additionally support control-plane traffic. More particularly, the CU 172 and the DU 174A/174B can exchange F1-AP messages over an F1-C interface that relies on a Stream Control Transmission Protocol (SCTP) layered over IP, where IP is layered over suitable data link and PHY layers similar to F1-U.

Similarly, an MRB 402B can include a DL tunnel 412B and, optionally, an UL tunnel 413B. The DL tunnel 412B can correspond to a DL logical channel 422B, and the UL tunnel 413B can correspond to the UL logical channel 423B.

The CU 172 in some cases uses a DRB 404A to transmit MBS data packets or unicast data packets associated with a PDU session, to a particular UE (e.g., the UE 102A or the UE 102B). The DRB 404A can include a UE-specific DL tunnel 432A connecting the CU 172 and the DU 174A/174B, and a DL logical channel 442A corresponding to the DL tunnel 432A. In particular, the DU 174A/174B can map downlink traffic received via the DL tunnel 432A to the DL logical channel 442A, which can be a DTCH, for example. The DRB 404A further includes a UE-specific UL tunnel 433A connecting the CU 172 and the DU 174A/174B, and a UL logical channel 443A corresponding to the UL tunnel 433A. The UL logical channel 443A can be a PUSCH, for example. The DU 174A/174B can map uplink traffic received via the UL logical channel 443A to the UL tunnel 433A.

Similarly, A DRB 404B can include a UE-specific DL tunnel 432B corresponding to a DL logical channel 442B, and a UE-specific UL tunnel 433B corresponding to a UL logical channel 443B.

In some implementations, a DU (e.g., the DU 174A/174B) assigns a particular logical channel ID (value) for each of the logical channel(s) associated with the MRB(s) associated with the same MBS session or different MBS sessions. In other implementations, the DU assigns the same logical channel ID (value) for each of the logical channel(s) associated with the MRB(s) associated with different MBS sessions. In some implementations, the DU assigns a particular logical channel ID (value) for each of the logical channel(s) associated with the DRB(s). In some implementations, the DU sets logical channel IDs associated with the MRB(s) and DRB(s) respectively to different values. In other implementations, the DU sets logical channel IDs associated with the MRB(s) and DRB(s) respectively to the same values.

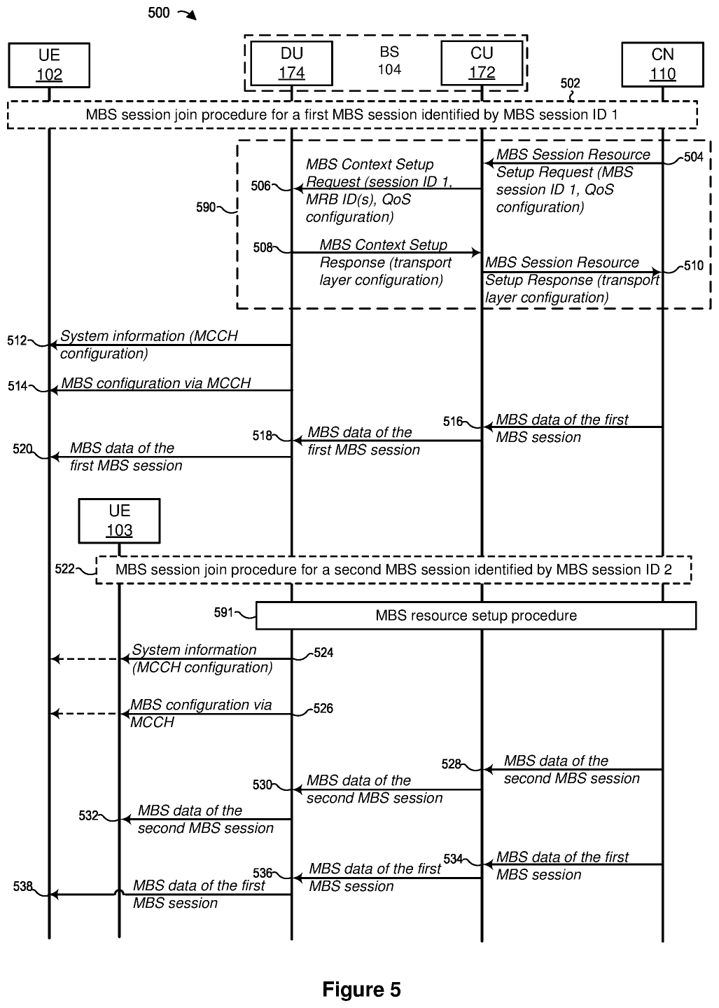

Next, FIG. 5 illustrates an example scenario 500 in which the base station 104, including a CU 172 and a DU 174, configures resources for transmitting MBS data of one or more MBS sessions via broadcast.

The UE 102 (i.e., (each of) the UEs 102A and/or 102B) initially can perform 502 a (first) MBS session join procedure with the CN 110 via the base station 104 to join a certain MBS session (i.e., a first MBS session). Because the base station 104 configures a common DL tunnel for MBS traffic rather than a UE-specific tunnel, as discussed below, the procedures 502 and 590 can occur in either order. In other words, the base station 104 can configure a common DL tunnel before even a single UE joins the MBS session.

In some implementations, the UE 102 can perform a PDU session establishment procedure with the CN 110 via the base station 104 to establish a PDU session in order to perform the (first) MBS session join procedure. During the PDU session establishment procedure, the UE 102 can communicate a PDU session ID of the PDU session with the CN 110 via the base station 104.

To perform the MBS session join procedure, the UE 102 in some implementations sends an MBS session join request message to the CN 110 via the base station 104. In response, the CN 110 can send an MBS session join response message to the UE 102 via the base station 104 to grant the UE 102 access to the first MBS session. In some implementations, the UE 102 can include a first MBS session ID (e.g., MBS session ID 1) of the first MBS session and/or the PDU session ID in the MBS session join request message. The CN 110 in some cases can include the first MBS session ID and/or the PDU session ID in the MBS session join response message. In some implementations, the UE 102 can send an MBS session join complete message to the CN 110 via the base station 104 in response to the MBS session join response message.

In some implementations, the MBS session join request message, MBS session join response message, and MBS session join complete message can be Internet Protocol (IP) packets, HTTP packets or session initiation protocol (SIP) messages. In such cases, these messages may not include the PDU session ID. In other implementations, the MBS session join request message, MBS session join response message, and MBS session join complete message can be NAS messages such as 5G mobility management (5GMM) messages or 5G session management messages (5GSM). In the case of the 5GSM messages, the UE 102 can transmit to the CN 110 via the base station 104 a (first) UL container message including the MBS session join request message, the CN 110 can transmit to the UE 102 via the base station 104 a DL container message including the MBS session join response message, and the UE 102 can transmit to the CN 110 via the base station 104 a (second) UL container message including the MBS session join complete message. These container messages can be 5GMM messages. In some implementations, the MBS session join request message, MBS session join response message, and MBS session join complete message can be a PDU Session Modification Request message, a PDU Session Modification Command message, and a PDU Session Modification Complete message, respectively. To simplify the following description, the IBS session join request message, the MBS session join response message, and/or the IBS session join complete message can represent the container messages.

Before, during, or after the first MBS session join procedure (event 502), the CN 110 can send 504 a (first) CN-to-BS message including the first MBS session ID (e.g., MBS session ID 1) and/or the PDU session ID to the CU 172 to request the CU 172 to configure resources for the first MBS session. The CN 110 can additionally include quality of service (QoS) configuration(s) for the first MBS session in the first CN-to-BS message. In response to receiving 504 the first CN-to-BS message, the CU 172 can send 506 a CU-to-DU message to the DU 174 to request a set-up for an MBS context and/or a common DL tunnel (i.e., a CU-to-DU common DL tunnel) for the first MBS session.

In response to receiving 506 the CU-to-DU message, the DU 174 can send 508, to the CU 172, a DU-to-CU message including a first DU DL transport layer configuration to configure a common CU-to-DU DL tunnel for the first MBS session or a MRB identified by one of the MRB ID(s). The DU 174 can include, in the DU-to-CU message, additional DL transport layer configuration(s) to configure additional common CU-to-DU DL tunnel(s) for additional MRB(s) identified by additional MRB ID(s) of the MRB IDs. In some implementations, the DU 174 can include, in the DU-to-CU message, the MRB ID(s) associated with the first DL transport layer configuration and/or the additional DL transport layer configuration(s). In some implementations, the CU-to-DU message is a generic F1AP message or a dedicated F1AP message defined specifically to convey this type of a request (e.g., MBS Context Setup Request message). In some implementations, the DU-to-CU message of event 508 is a generic F1AP message or a dedicated F1AP message defined specifically for this purpose (e.g., MBS Context Setup Response message). The CN 110 can additionally include quality of service (QoS) configuration(s) for the first MBS session. In such cases, the CU 172 can include the QoS configuration(s) in the CU-to-DU message (event 506). In some implementations, the CU-to-DU message and DU-to-CU message can be non-UE-specific messages.

The CU 172 sends 510 a first BS-to-CN message (e.g., MBS Session Resource Setup Response message) in response to the message of event 504. The CU 172 can include the first MBS session ID and/or the PDU session ID in the first BS-to-CN message. The first BS-to-CN message can include a DL transport layer configuration to configure a common DL tunnel (i.e., a CN-to-BS common DL tunnel) for the CN 110 to send MBS data to the CU 172. The DL transport layer configuration includes a transport layer information, such as a transport layer address (e.g., an IP address) and/or a TEID, to identify the common DL tunnel. In some implementations, the CN-to-BS message of event 504 is a generic NGAP message or a dedicated NGAP message defined specifically for requesting resources for an MBS session (e.g., MBS Session Resource Setup Request message). In some implementations, the BS-to-CN message of event 510 is a generic NGAP message or a dedicated NGAP message defined specifically to convey resources for an MBS session (e.g., MBS Session Resource Setup Response message). In such cases, the CN-to-BS message of event 504 and the BS-to-CN message of event 510 can be non-UE-specific messages.

In some implementations, the QoS configuration(s) include QoS parameters for the MBS session. In some implementations, the QoS configuration includes configuration parameters to configure one or more QoS flows for the MBS session (see FIG. 3). In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5QI), a priority level, packet delay budget, packet error rate, averaging window, and/or a maximum data burst volume. The CN 110 can specify different values of the QoS parameters for the QoS flows.

The events 504, 506, 508, and 510 are collectively referred to in FIG. 5A as an MBS resource setup procedure 590. In cases where the UE 102 performs the MBS session join procedure to join the first MBS session, the CN 110 can perform the procedure 590 with the base station 104 before, during or after the (first) MBS session join procedure (event 502).

In some implementations, the CN 110 may refrain from including a UL transport layer configuration for the first MBS session in the first CN-to-BS message. In such cases, the CU 172 may refrain from including a UL transport layer configuration for the first MBS session in the CU-to-DU message.

Before, during or after the MBS resource setup procedure 590, the DU 174 transmits (e.g., broadcast) 512 system information (e.g., one or more system information blocks (SIBs)) including MBS control channel (MCCH) configuration on one or more cells (e.g., cell 124 and/or other cell(s) operated by the DU 174). The DU 174 transmits (e.g., broadcast) 514 an MBS configuration via a MCCH configured by the MCCH configuration.

In some implementations, the MCCH configuration includes configuration parameters such as a window start slot, a window duration, a modification period, and/or a repetition period and offset. The window duration indicates a duration (i.e., MCCH transmission window in units of e.g., (consecutive) slots), starting from a slot indicated by the window start slot, during which transmissions of MCCH information (i.e., transmission(s) of the MBS configuration(s) via MCCH) may be scheduled. The modification period defines periodically appearing boundaries, i.e., radio frames for which SFN mod the modification period=0. Contents of different transmissions of MCCH information can only be different if there is at least one such boundary in-between them. The repetition period and offset parameter defines a length and an offset of the MCCH repetition period. Transmissions of MCCH information are scheduled in radio frames for which system frame number (SFN) mod the repetition period length offset of the repetition period.

In some implementations, the MBS configuration includes MBS session information list includes a list of MBS session information IE(s) (i.e., information related one or more MBS sessions including the first MBS session). For example, an MBS session information IE in the list includes an MBS session ID, a G-RNTI, MRB configuration(s), RLC configuration(s) and/or DRX information. The MBS session ID identifies an MBS session, the G-RNTI is used to schedule transmissions of MBS data of the MBS session, the MRB configuration(s) configures one or more MRBs, the RLC configuration(s) configures RLC parameters for the MRB(s), and the DRX information configures DRX related parameters for transmission of MBS data of the MBS session. Each of the MRB configuration(s) can configure an MRB. For example, a MRB configuration includes a PDCP configuration for the MRB. In the scenario 500, an MBS session information IE (i.e., first MBS session information IE) in the list includes the first MBS session ID, MRB configuration(s) configuring one or more MRBs for the first MBS session, a (first) G-RNTI used by the DU 174 to schedule transmissions of IBS data of the MRB(s) or the first MBS session, RLC configuration(s) for the MRB(s) and/or DRX information configuring DRX related parameters for transmission of IBS data of the MRB(s) or the first MBS session.

In some implementations, the DU 174 can (start to) transmit 512 the system information in response to performing 590 the MBS resource setup procedure. In some implementations, the CU 172 generates the system information and transmit the system information to the DU 174. In other implementations, the DU 174 generates the system information.

In some implementations, the DU 174 can (start to) transmit 514 the MBS configuration(s) in response to performing 590 the MBS resource setup procedure. In some implementations, the CU 172 generates the MBS configuration and transmit the MBS configuration to the DU 174. In other implementations, the DU 174 generates the MBS configuration as described below. In yet other implementations, the CU 172 generates a (first) portion of the MBS configuration, and the DU 174 generates a (second) portion of the MBS configuration (i.e., the rest of the MBS configuration). Details of these different implementations will be described below.

In some implementations, the CU 172 can transmit to the DU 174 a CU-to-DU message including configuration parameters for the first MBS session, such as the first MBS session ID, QoS configuration(s), DRX cycle configuration, MRB ID(s) of the MRB(s), and/or PDCP configuration(s) of the MRB(s). In some implementations, the DU 174 can generate the MBS session information IE in accordance with the configuration parameters. In some implementations, the DU 174 can generate at least a portion of the MBS session information IE, e.g., in accordance with preconfigured value(s). For example, the DU 174 can generate the MRB configuration(s), which includes the PDCP configuration(s), the MRB ID(s) and/or the first MBS session ID received from the CU 172. Alternatively, the DU 174 can generate the MRB configuration(s), which includes the PDCP configuration(s), the MRB ID(s) and/or the first MBS session ID with preconfigured values. In some implementations, the DU 174 may not include a MRB ID in the MRB configuration(s). The DU 174 can generate the RLC configuration(s) (e.g., including the MRB ID(s)) for the MRB(s), e.g., in accordance with the QoS configuration(s) and/or the MRB ID(s). Alternatively, the DU 174 can generate the RLC configuration(s) with pre-configured RLC parameters. The DU 174 can assign logical channel ID(s) for the MRB(s) and include the logical channel ID(s) in the MBS session information IE or the RLC configuration(s). In another example, the DU 174 can generate the DRX information configuring a DRX cycle in accordance with the DRX cycle configuration received from the CU 172. Alternatively, the DU 174 determines the DRX cycle, e.g., in accordance with the QoS configuration(s) received from the CU 172. In yet another example, the DU 174 can assign the G-RNTI and associate the G-RNTI with the first MBS session ID. In such cases, the DU 174 can generate the MBS session information and the MBS configuration (e.g., an MBS broadcast configuration message) including the MBS session information, and transmit 513 the MBS configuration via the MCCH on the one or more cells. In some implementations, the CU-to-DU message can be a CU-to-DU message of the MBS resource setup procedure 589, similar to event 506. In other implementations, the CU-to-DU message can be a (second) message other than the CU-to-DU message of the MBS resource setup procedure 589.

In other implementations, the DU 174 can transmit to the CU 172 a DU-to-CU message including the RLC bearer configuration(s), the DRX information and the G-RNTI. In such implementations, the CU 172 generates the MRB configuration(s), which includes the PDCP configuration(s), the MRB ID(s) and/or the first MBS session ID. After receiving the DU-to-CU message, the CU 172 generates the MBS session information and the MBS configuration (e.g., an MBS broadcast configuration message) including the MBS session information, for (each of) the one or more cells. Then the CU 172 transmits a CU-to-DU message including the MBS configuration to the DU 174. After receiving the MBS configuration from the CU 172, the DU 174 transmits 513 the MRB configuration via the MCCH. In some implementations, the CU 172 can send a CU-to-DU message to the DU 174 to request the DU 174 to send the DU-to-CU message. In such cases, the DU 174 sends the DU-to-CU message to the CU 172 in response to the CU-to-DU message.

In some implementations, the DU 174 can transmit 508 the DU-to-CU message to the CU 172 after transmitting 512 the system information and/or 514 the MBS configuration. In other implementations, the DU 174 can transmit 508 the DU-to-CU message to the CU 172 before transmitting 512 the system information and/or 514 the MBS configuration.

After receiving 510 the first BS-to-CN message, transmitting 512 the system information, and/or transmitting 514 the MBS configuration, the CN 110 can send 516 MBS data (e.g., one or multiple MBS data packets) of the first MBS session to the CU 172 via the common CN-to-BS DL tunnel (i.e., the first common CN-to-BS DL tunnel), which in turn sends the 518 the MBS data to the DU 174 in accordance with the PDCP configuration(s) via the common CU-to-DU DL tunnel (i.e., the first CU-to-DU common DL tunnel). The DU 174 transmits (e.g., broadcast) 520 the MBS data (e.g., via the logical channel(s) identified by the logical channel ID(s), and/or using the RLC configuration(s) and/or G-RNTI). The UE 102 receives 520 the MBS data in accordance with the first MBS session information IE. For example, the CU 172 receives 516 an MBS data packet, generates a PDCP PDU including the MBS data packet using the PDCP configuration, and transmits 518 the PDCP PDU to the DU 174 via the first common CU-to-DU DL tunnel. In turn, the DU 174 generates a MAC PDU including the logical channel ID and the PDCP PDU, and transmits 520 the MAC PDU to the UE 102 using the first G-RNTI via broadcast. The UE 102 receives 520 the MAC PDU using the first G-RNTI, retrieves the PDCP PDU and the logical channel ID from the MAC PDU, identifies the PDCP PDU associated with the MRB, and retrieves the MBS data packet from the PDCP PDU using the PDCP configuration.

With continued reference to FIG. 5, the UE 103 (e.g., (each of) the UE 103A and/or the UE 103B) can perform 522 an MBS session join procedure to join a second MBS session identified by a second MBS session ID (e.g., MBS session ID 2), similar to the procedure 502 discussed above. The base station 104 can perform 591 an MBS session resource setup procedure with the CN 110 to configure a second common CN-to-BS DL tunnel and a second common CU-to-DU DL tunnel for the second MBS session, similar to the procedure 590.

Before, during or after the MBS resource setup procedure 591, the DU 174 transmits (e.g., broadcast) 524 system information (e.g., one or more system information blocks (SIBs)) including MCCH configuration on one or more cells (e.g., cell 124 and/or other cell(s) operated by the DU 174), similar to the event 512. The DU 174 transmits (e.g., broadcast) 526 an MBS configuration via a MCCH configured by the MCCH configuration, similar to the event 514. In such cases, an MBS configuration or an MBS session information list of the event 526 can include the first MBS session information IE and a second MBS session information IE for the second MBS session. For example, the second MBS session information includes the second MBS session ID, MRB configuration(s) configuring one or more MRBs for the second MBS session, a (second) G-RNTI used by the DU 174 to schedule transmissions of MBS data of the MRB(s) or the second MBS session, RLC configuration(s) for the MRB(s) and/or DRX information configuring DRX related parameters for transmission of MBS data of the MRB(s) or the second MBS session. The first and second MBS session IDs have different values. The G-RNTI for the first MBS session and the G-RNTI for the second MBS session have different values. The DRX information for the first MBS session and the DRX information for the second MBS session can be the same or different.

In some implementations, configuration parameters in the first MBS session information IE and configuration parameters in the second MBS session information IE may have the same values. This simplifies implementations of the base station 104. For example, the PDCP configuration(s) in the first MBS session information IE and the PDCP configuration(s) in the second MBS session information IE may have the same values. In another example, the RLC configuration(s) in the first MBS session information IE and the RLC configuration(s) in the second MBS session information IE may have the same values. In other implementations, configuration parameters in the first MBS session information IE and configuration parameters in the second MBS session information IE may have different values. The CU 172 and/or DU 174 can optimize the configuration parameters for the first and second MBS sessions, respectively, in cases where the first and second MBS sessions may require different QoS characteristics. For example, the PDCP configuration(s) in the first MBS session information IE and the PDCP configuration(s) in the second MBS session information IE may have different values. In another example, the RLC configuration(s) in the first MBS session information IE and the RLC configuration(s) in the second MBS session information IE may have different values.

In some implementations, the PDCP configuration(s) include PDCP sequence number size(s) and/or header compression configuration(s). In some implementations, the RLC configuration(s) include RLC sequence number size(s) or reassembly timer value(s).

After performing 591 the MBS resource setup procedure, transmitting 524 the system information, and/or transmitting 526 the MBS configuration, the CN 110 can send 528 MBS data (e.g., one or multiple MBS data packets) of the second MBS session to the CU 172 via the second common CN-to-BS DL tunnel, which in turn sends the 530 the MBS data to the DU 174 in accordance with the PDCP configuration(s) via the second common CU-to-DU DL tunnel. The DU 174 transmits (e.g., broadcast) 532 the MBS data in accordance with the second MBS session information IE (e.g., via the logical channel(s) identified by the logical channel ID(s), and/or using the RLC configuration(s) and/or second G-RNTI). The UE 103 receives 532 the MBS data in accordance with the second MBS session information IE. For example, the CU 172 receives 528 an MBS data packet, generates a PDCP PDU including the MBS data packet using the PDCP configuration, and transmits 530 the PDCP PDU to the DU 174 via the second common CU-to-DU DL tunnel. In turn, the DU 174 generates a MAC PDU including the logical channel ID and the PDCP PDU, and transmits 532 the MAC PDU to the UE 103 using the second G-RNTI via broadcast. The UE 103 receives 532 the MAC PDU using the second G-RNTI, retrieves the PDCP PDU and the logical channel ID from the MAC PDU, identifies the PDCP PDU associated with the MRB and retrieves the MBS data packet from the PDCP PDU using the PDCP configuration.

After performing 591 the MBS resource setup procedure or transmitting 528 the MBS data, the CN 110 sends 534 MBS data of the first MBS session to the CU 172 via the first common CN-to-BS DL tunnel, similar to the event 516. In turn, the CU 172 transmits 536 the MBS data to the DU 174 via the first common CU-to-DU DL tunnel, similar to the event 518. The DU 174 then transmits (i.e., broadcast) 538 the MBS data, similar to the event 520. The UE 102 receives 538 the MBS data in accordance with the first MBS session information 514, similar to the event 520.

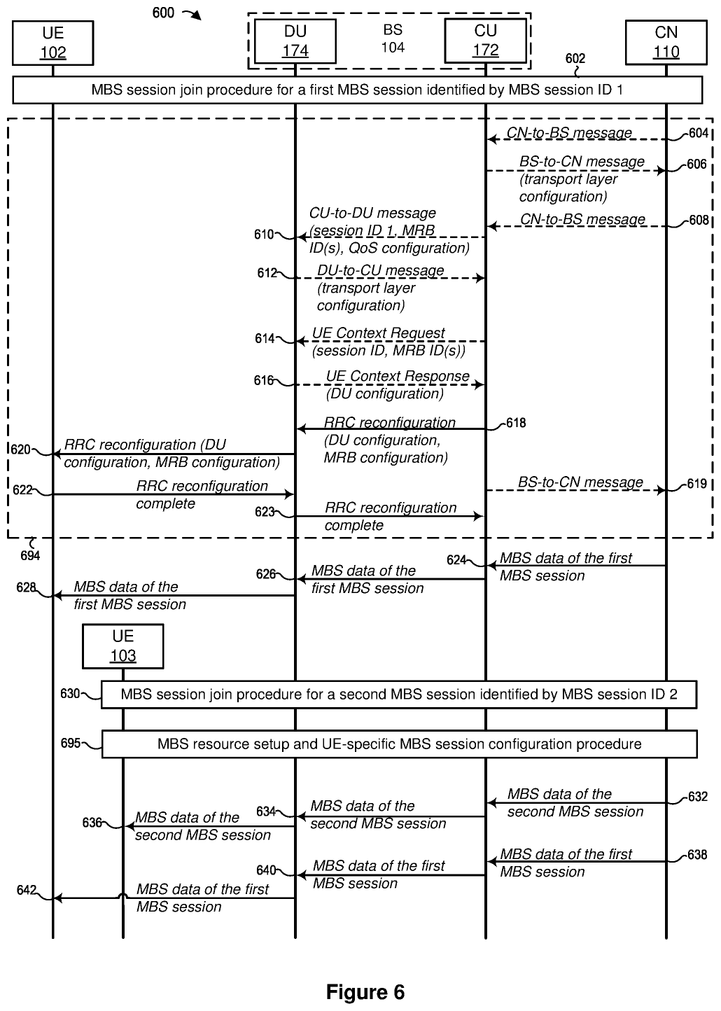

Next, FIG. 6 illustrates an example scenario 600 in which the base station 104, including a CU 172 and a DU 174, configures resources for transmitting MBS data of one or more MBS sessions via multicast or unicast.

The UE 102 (i.e., (each of) the UEs 102A and/or 102B) initially performs 602 a (first) MBS session join procedure with the CN 110 via the base station 104 to join a certain MBS session (i.e., a first MBS session), similar to the event 502.

Before, during, or after the (first) MBS session join procedure (event 602), the CN 110 can send 604 a (first)CN-to-BS message including the first MBS session ID and/or the PDU session ID to the CU 172 to request the CU 172 to configure resources for the first MBS session. The CN 110 can additionally include, in the CN-to-BS message, quality of service (QoS) configuration(s) for the first MBS session. In response, the CU 172 can (determine to) send 606 a (first) BS-to-CN message including a DL transport layer configuration to configure a common DL tunnel (i.e., a first common CN-to-BS DL tunnel) for the CN 110 to send MBS data to the CU 172. The DL transport layer configuration includes a transport layer address (e.g., an IP address) and/or a TEID to identify the common DL tunnel. The CU 172 can include the first MBS session ID and/or the PDU session ID in the BS-to-CN message. In cases where the CU 172 has configured a common DL tunnel has for the first MBS session before receiving the BS-to-CN message, the CU 172 determines not send the BS-to-CN message. That is, the CU 172 refrains from sending the BS-to-CN message.

In some implementations, the CN-to-BS message of event 604 can be a generic NGAP message or a dedicated NGAP message defined specifically for requesting resources for an MBS session (e.g., MBS Session Resource Setup Request message). In some implementations, the BS-to-CN message of event 606 is a generic NGAP message or a dedicated NGAP message defined specifically to convey resources for an MBS session (e.g., MBS Session Resource Setup Response message). In such cases, the CN-to-BS message of event 604 and the BS-to-CN message of event 606 can be non-UE-specific messages.

In some implementations, the CN 110 can indicate, in the CN-to-BS message of event 604, a list of UEs joining the first MBS session. In other implementations, the CN 110 can send 608 to the CU 172 a second CN-to-BS message indicating a list of UEs joining the first MBS session. The CN 110 can include the first MBS session ID and/or the PDU session ID in the second CN-to-BS message. The CU 172 can send 619 a second BS-to-CN message to the CN 110 in response to the second CN-to-BS message 608. In such cases, the second CN-to-BS message and the second BS-to-CN message can be non-UE-specific messages. For example, the list of UEs includes the UE 102A and/or UE 102B. To indicate a list of UEs, the CN 110 can include a list of (CN UE interface ID, RAN UE interface ID) pairs, each identifying a particular UE of the UEs. For example, the list of pairs includes a first pair of (a first CN UE interface ID and a first RAN UE interface ID) identifying the UE 102A and a second pair of (a second CN UE interface ID, a second RAN UE interface ID) identifying the UE 102B. In some implementations, the “CN UE interface ID” can be an “AMF UE NGAP ID” and the “RAN UE interface ID” can be a “RAN UE NGAP ID.” In other implementations, the CN 110 can include a list of UE IDs, each identifying a particular UE in the set of UEs. In some implementations, the CN 110 can assign the UE IDs and send each of the UE IDs to a particular UE of the UEs in a NAS procedure (e.g., registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs).

In some alternative implementations, the CN 110 can send 608 to the CU 172 another, second CN-to-BS message indicating that the UE 102 (e.g., a single UE such as UE 102A or UE 102B) joins the first MBS session. The CU 172 can send 619 another, second BS-to-CN message to the CN 110 in response to the second CN-to-BS message 608. In such cases, the CN 110 can include the MBS session join response message for the UE 102 in the second CN-to-BS message. The CU 172 can include a first CN UE interface ID and a first RAN UE interface ID, identifying the UE 102, in the second CN-to-BS message. In some implementations, the second CN-to-BS message and the second BS-to-CN message can be UE-specific NGAP messages, such as a PDU Session Resource Modify Request message and a PDU Session Resource Modify Response message, respectively.

In other implementations, the first CN-to-BS message can be a UE-specific NGAP message (e.g., PDU Session Resource Modify Request message) indicating that the UE 102 (e.g., a single UE such as UE 102A or UE 102B) joins the first MBS session. The CN 110 can include an MBS session join response message for the UE 102 in the first CN-to-BS message. The CU 172 can include the first CN UE interface ID and the first RAN UE interface ID, identifying the UE 102, in the first CN-to-BS message. In some implementations, the first BS-to-CN message can be a generic NGAP message or a dedicated NGAP message defined specifically to convey resources for an MBS session (e.g., MBS Session Resource Setup Indication message or RAN Configuration Update message). The CN 110 can send 608 another, second CN-to-BS message (e.g., MBS Session Resource Setup Confirm message or RAN Configuration Update Acknowledge message) to the CU 172 in response to the first BS-to-CN message. The CU 172 can send 619 to the CN 110 another, second BS-to-CN message (e.g., PDU Session Resource Modify Response message) in response to the first CN-to-BS message.

In some implementations, the CN 110 can include the MBS session join response message for the UE 102 in another CN-to-BS message instead of the first CN-to-BS message or the second CN-to-BS message.

In some implementations, the QoS configuration(s) include QoS parameters for the MBS session. In some implementations, the QoS configuration includes configuration parameters to configure one or more QoS flows for the MBS session (see FIG. 3). In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5QI), a priority level, packet delay budget, packet error rate, averaging window, and/or a maximum data burst volume. The CN 110 can specify different values of the QoS parameters for the QoS flows.

In cases where the CU 172 establishes the common DL tunnel for the first MBS session as described above, the CU 172 may refrain from including a DL transport layer configuration for the first MBS session in the second BS-to-CN message. In such cases, the CN 110 may refrain from including a UL transport layer configuration for the first MBS session in the first CN-to-BS message and/or second CN-to-BS message.

In response to or after receiving 604 the first CN-to-BS message, transmitting 606 the first CN-to-BS message or receiving 608 the second CN-to-BS message, the CU 172 can send 610 a CU-to-DU message to the DU 174 to request a set-up for an MBS context and/or a common DL tunnel for the first MBS session. In response to receiving 610 the CU-to-DU message, the DU 174 can send 612, to the CU 172, a DU-to-CU message including a first DU DL transport layer configuration to configure a common CU-to-DU DL tunnel (i.e., a first CU-to-DU common DL tunnel) for the first MBS session. In some implementations, the CU-to-DU message is a generic F1AP message or a dedicated F1AP message defined specifically to convey this type of a request (e.g., MBS Context Setup Request message). In some implementations, the DU-to-CU message of even 612 is a generic F1AP message or a dedicated F1AP message defined specifically for this purpose (e.g., MBS Context Setup Response message). In such cases, the CU 172 can include the QoS configuration(s) in the CU-to-DU message (event 610). In some implementations, the CU-to-DU message and DU-to-CU message can be non-UE-specific messages.

In response to or after receiving 604 the first CN-to-BS message, transmitting 606 the first CN-to-BS message, receiving 608 the second CN-to-BS message, transmitting 610 the CU-to-DU message or receiving 612 the DU-to-CU message, the CU 172 can send 614 to the DU 174 a UE Context Request message for the UE 102. In some implementations, the CU 172 can include, in the UE Context Request message, the first MBS session ID and/or MRB ID(s) of MRB(s) associated to the first MBS session (ID). In response to the UE Context Request message, the DU 174 sends 616 to the CU 172 a UE Context Response message including configuration parameters for the UE 102A to receive MBS data of the first MBS session. In some implementations, the CU 172 can include the QoS configuration(s) in the UE Context Request message. In such cases, the CU 172 may or may not include the QoS configuration(s) in the CU-to-DU message. (Some of) the configuration parameters may be associated to the MRB(s)/MRB ID(s). In some implementations, the DU 174 generates a DU configuration to include the configuration parameters and includes the DU configuration in the UE Context Response message. In some implementations, the DU configuration can be a CellGroupConfig IE. In other implementations, the DU configuration can be an MBS specific IE. In some implementations, the configuration parameters configure one or more logical channels (LCs). For example, the configuration parameters include one or more logical channel IDs (LCIDs) to configure the one or more logical channel. Each of the LCIDs identifies a particular logical channel of the one or more logical channels.

Instead of that the CU 172 transmits 606 the CU-to-DU message to request to configure a common CU-to-DU DL tunnel, the DU 174 in some implementations can transmit 608 the DU-to-CU message in response to receiving 614 the UE Context Request message in addition to transmitting 616 the UE Context Response message. Then, the CU 172 can send a CU-to-DU response message to the DU 174 in response to the DU-to-CU message. In such cases, the DU-to-CU message and the CU-to-DU response message can be non-UE associated messages, i.e., the messages are not associated to a particular UE.

In some implementations, the CN 110 includes the QoS configuration(s) in the second CN-to-BS message. In such cases, the CN 110 may include the QoS configuration(s) in the first CN-to-BS message, or omit the QoS configuration(s). In some implementations, the DU 174 generates the configuration parameters for the UE 102 to receive MBS data of the first MBS session in response receiving the CU-to-DU message or the UE Context Request message. In some implementations, the CU 172 includes the QoS configuration(s) in the UE Context Request message and/or the CU-to-DU message. The DU 174 can determine the content of the configuration parameters in accordance with the QoS configuration(s). When the CU 172 includes the QoS configuration(s) neither in the CU-to-DU message nor the UE Context Request message, the DU 174 can determine values of the configuration parameters in accordance with a predetermined QoS configuration.

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively.

After receiving 616 the UE Context Response message, the CU 172 generates an RRC reconfiguration message including the configuration parameters and one or more MRB configurations and transmits 618 the RRC reconfiguration message to the DU 174. In turn, the DU 174 transmits 620 the RRC reconfiguration message to the UE 102. In response, the UE 102 then transmits 622 a RRC reconfiguration complete message to the DU 174, which in turn transmits 623 the RRC reconfiguration complete message to the CU 172.

In some implementations, the CU 172 generates a PDCP PDU including the RRC reconfiguration message and sends 618 a CU-to-DU message including the PDCP PDU to the DU 174, and the DU 174 retrieves the PDCP PDU from the CU-to-DU message and transmits 620 the PDCP PDU to the UE 102 via the RLC layer 206B, MAC layer 204B and PHY layer 202B. The UE 102 receives 620 the PDCP PDU from the DU 174 via the PHY layer 202B, MAC layer 204B and RLC layer 206B. In some implementations, the UE 102 generates a PDCP PDU including the RRC reconfiguration complete message and transmits 622 the PDCP PDU to the DU 174 via the RLC layer 206B, MAC layer 204B and PHY layer 202B. The DU 174 receives 622 the PDCP PDU from the UE 102 via the PHY layer 202B, MAC layer 204B and RLC layer 206B and sends 623 a DU-to-CU including the PDCP PDU to the CU 172. The CU 172 retrieves the PDCP PDU from the DU-to-CU message and retrieves the RRC reconfiguration complete message from the PDCP PDU.

Before or after receiving 616 the UE Context Response message, the CU 172 can send 619 the second BS-to-CN message to the CN 110 in response to the second CN-to-BS message 612. In some implementations, the CU 172 sends 619 the second BS-to-CN message to the CN 110 before receiving 623 the RRC reconfiguration complete message. In other implementations, the CN 110 sends 619 the second BS-to-CN message to the CN 110 after receiving 623 the RRC reconfiguration complete message. The CU 172 can include the first CN UE interface ID and the first RAN UE interface ID in the second BS-to-CN message. Alternatively, the CU 172 can include the first UE ID in the second BS-to-CN message.

The events 604, 606, 608, 612, 614, 616, 618, 619, 620, 622 and 623 are collectively referred to in FIG. 6 as an MBS resource setup and UE-specific MBS session configuration procedure 694. In some implementations, respective instances of the events 604 or 608, 614, 616, 618, 619, 620, 622, 623 occur for each of the UE 102A and the UE 102B. The configuration parameters for the UE 102A and the UE 102B to receive MBS data of the first MBS session can be the same. In some implementations, the MBS session join procedure of event 602 include the UE-specific MBS session resource setup procedure 694.

After receiving 606 the first BS-to-CN message or 619 the second BS-to-CN message, the CN 110 can send 624 MBS data (e.g., one or multiple MBS data packets) to the CU 172 via the first common CN-to-BS DL tunnel, which in turn sends the 626 the MBS data to the DU 174 via the first common CU-to-DU DL tunnel. The DU 174 transmits (e.g., multicast or unicast) 628 the MBS data via the one or more logical channels to the UE 102 (i.e., the UE 102A and/or the UE 102B). The UE 102 receives 628 the MBS data via the one or more logical channels. For example, the CU 172 receives 624 an MBS data packet, generates a PDCP PDU including the MBS data packet using the PDCP configuration, and transmits 626 the PDCP PDU to the DU 174 via the first common CU-to-DU DL tunnel. In turn, the DU 174 generates a MAC PDU including the logical channel ID and the PDCP PDU, and transmits 628 the MAC PDU to the UE 102 via multicast or unicast. The UE 102 receives 628 the MAC PDU via multicast or unicast, retrieves the PDCP PDU and the logical channel ID from the MAC PDU, identifies the PDCP PDU associated with the MRB in accordance with the logical channel ID, and retrieves the MBS data packet from the PDCP PDU in accordance with a PDCP configuration within the MRB configuration.

In some implementations, the CU 172 can (determine to) configure a UE-specific CN-to-BS DL tunnel for the UE 102 in response to receiving the first or second CN-to-BS message. In such cases, the CU 172 can omit the event 606, and can include, in the second BS-to-CN message, a DL transport layer configuration configuring a UE-specific DL tunnel. The CN 110 can transmit 624 the MBS data to the CU 172 via the UE-specific CN-to-BS DL tunnel. In some implementations, the CU 172 can (determine to) configure a UE-specific CU-to-DU DL tunnel for the UE 102 in response to receiving the first or second CN-to-BS message. In such cases, the CU 172 can omit the event 610 and the DU 174 can include, in the UE Context Response message, a DL transport layer configuration configuring a UE-specific CU-to-DU DL tunnel. In such cases, the CU 174 can transmit 626 the MBS data to the DU 174 via the UE-specific CU-to-DU DL tunnel.

In some implementations, the one or more MRB configurations configuring one or more MRBs are associated with the first MBS session. In some implementations, the configuration parameters also include one or more RLC bearer configurations, each associated with a particular MRB. Each of the MRB configuration(s) can include a MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the logical channel can be a multicast traffic channel (MTCH). In other implementations, the logical channel can be a dedicated traffic channel (DTCH). In some implementations, the configuration parameters may include logical channel configuration (e.g., LogicalChannelConfig IE) configuring configure the logical channel. In some implementations, the RLC bearer configuration may include the MRB ID.

In some implementations, the CU 172 can configure the MRB as a DL-only RB in the MRB configuration. For example, the CU 172 refrains from including UL configuration parameters in the PDCP configuration within the MRB configuration to configure the MRB as a DL only RB. The CU 172 only includes DL configuration parameters in the MRB configuration, e.g., as described above. In such cases, the CU 172 configures the UE 102 not to transmit UL PDCP data PDU via the MRB to the DU 174 and/or the CU 172 by excluding the UL configuration parameters for the MRB in the PDCP configuration in the MBR configuration. In another example, the DU 174 refrains from including UL configuration parameters in the RLC bearer configuration. In such cases, the DU 174 configures the UE 102 not to transmit control PDU(s) via the logical channel to the DU 174 by excluding the UL configuration parameters from the RLC bearer configuration.

In cases where the DU 174 includes UL configuration parameter(s) in the RLC bearer configuration, the UE 102 may transmit control PDU(s) (e.g., PDCP Control PDU(s) and/or RLC Control PDU(s)) via the logical channel to the DU 174 using the UL configuration parameter(s). If the control PDU is a PDCP control PDU, the DU 174 can send the PDCP control PDU to the CU 172. For example, the CU 172 may configure the UE to receive MBS data with a (de)compression protocol (e.g., robust header compression (ROHC) protocol), e.g., in the MRB configuration. In this case, when the CU 172 receives 624 an MBS data packet from the CN 110, the CU 172 compresses the MBS data packet with the compression protocol to obtain a compressed MBS data packet and transmits 626 a PDCP PDU including the compressed MBS data packet to the DU 174 via the common CU-to-DU DL tunnel. In turn, the DU 174 transmits (e.g., multicast or unicast) 628 the PDCP PDU to the UE 102 via the logical channel. When the UE 102 receives the PDCP PDU via the logical channel, the UE 102 retrieves the compressed MBS data packet from the PDCP PDU. The UE 102 decompresses the compressed MBS data packet with the (de)compression protocol to obtain the original MBS data packet. In such cases, the UE 102 may transmit a PDCP Control PDU including, a header compression protocol feedback (e.g., interspersed ROHC feedback) for operation of the header (de)compression protocol, via the logical channel to the DU 174. In turn, the DU 174 sends the PDCP Control PDU to the CU 172 via a UE-specific UL tunnel, i.e., the UL tunnel is specific for the UE 102 (e.g., the UE 102A). In some implementations, the CU 172 can include, in the UE Context Request message, a CU UL transport layer configuration configuring the UE-specific UL tunnel. The CU UL transport layer configuration includes a CU transport layer address (e.g., an Internet Protocol (IP) address) and a CU UL TEID to identify the UE-specific UL tunnel.

In some implementations, the MRB configuration can be an MRB-ToAddMod IE including an MRB ID (e.g., mrb-Identity or MRB-Identity). A MRB ID identifies a particular MRB of the MRB(s). The CU 172 sets the MRB IDs to different values. In cases where the CU 172 has configured DRB(s) to the UE 102 for unicast data communication, the CU 172 in some implementations can set the MRB ID(s) to values different from DRB ID(s) of the DRB(s). In such cases, the UE 102 and the CU 172 can distinguish whether an RB is a MRB or DRB in accordance an RB ID of the RB. In other implementations, the CU 172 can set one or more of the MRB ID(s) to values which can be the same as one or more of the DRB ID(s). In such cases, the UE 102 and the CU 172 can distinguish whether an RB is a MRB or DRB in accordance an RB ID of the RB and a RRC IE configuring the RB. For example, a DRB configuration configuring a DRB is a DRB-ToAddMod IE including a DRB identity (e.g., drb-Identity or DRB-Identity) and a PDCP configuration. Thus, the UE 102 can determine that an RB is a DRB if the UE 102 receives a DRB-ToAddMod IE configuring the RB, and determine that an RB is an MRB if the UE 102 receives an MRB-ToAddMod IE configuring the RB. Similarly, the CU 172 can determine that an RB is a DRB if the CU 172 transmits a DRB-ToAddMod IE configuring the RB to the UE 102, and determine that an RB is an MRB if the CU 172 transmits an MRB-ToAddMod IE configuring the RB to the UE 102.

In some implementations, the configuration parameters for receiving MBS data of the first MBS session include one or more logical channel (LC) IDs to configure one or more logical channels. In some implementations, the logical channel(s) can be dedicated traffic channel(s) (DTCH(s)). In other implementations, the logical channel(s) can be multicast traffic channel(s) (MTCH(s)). In some implementations, the configuration parameters may or may not include a group radio network temporary identifier (G-RNTI). The RRC reconfiguration messages for UEs (e.g., the UE 102A and the UE 102B) joining the first MBS session, include the same configuration parameters for receiving MBS data of the first MBS session. In some implementations, the RRC reconfiguration messages for the UEs may include the same or different configuration parameters for receiving non-MBS data.

In some implementations, the CU 172 can include the MBS session join response message in the RRC reconfiguration message. The UE 102 can include the MBS session join complete message in the RRC reconfiguration complete message. Alternatively, the UE 102 can send a UL RRC message including the MBS session join complete message to the CU 172 via the DU 174. The UL RRC message can be a ULInformationTransfer message or any suitable RRC message that can include a UL NAS PDU. The CU 172 can include the MBS session join complete message in the second BS-to-CN message. Alternatively, the CU 172 can send to the CN 110 a BS-to-CN message (e.g., an UPLINK NAS TRANSPORT message) including the MBS session join complete message.

In other implementations, the CU 172 transmits a DL RRC message that MBS session join response message to the UE 102 via the DU 174. The DL RRC message can be a DLInformationTransfer message, another RRC reconfiguration message, or any suitable RRC message that can include a DL NAS PDU. The UE 102 can send a UL RRC message including the MBS session join complete message to the CU 172 via the DU 174. The UL RRC message can be a ULInformationTransfer message, another RRC reconfiguration complete message, or any suitable RRC message that can include a UL NAS PDU.

With continued reference to FIG. 6, the UE 103 (e.g., (each of) the UE 103A and/or the UE 103B) can perform 630 an MBS session join procedure to join a second MBS session identified by a second MBS session ID (e.g., MBS session ID 2), similar to the procedure 602 discussed above. The CU 172 can perform 695 an MBS resource setup and UE-specific MBS session configuration procedure with the DU 174, the UE 103 and the CN 110 to transmit to the UE 103 configuration parameters and one or more MRB configurations for the second MBS session, similar to the procedure 694. In the procedure 695, the CU 172 transmits to the CN 110 a BS-to-CN message including a DL transport layer configuration configuring a second common CN-to-BS DL tunnel, similar to the event 606. In the procedure 695, the DU 174 transmits to the CU 172 a DU-to-CU message including a DL transport layer configuration configuring a second common CU-to-DU DL tunnel, similar to the event 612. Some or all of the configuration parameters and the MRB configuration(s) of the procedure 695 may be different from the configuration parameters and the MRB configuration(s) of the procedure 694. For example, the configuration parameters of the procedure 695 includes a second G-RNTI (value) different from the G-RNTI (value) within the configuration parameters of the procedure 694. In another example, the MRB configuration(s) of the procedure 695 includes MRB ID(s) different from the MRB ID(s) within the configuration parameters of the procedure 694.

After the procedure 695, the CN 110 can send 632 MBS data of the second MBS session (e.g., one or multiple MBS data packets) to the CU 172 via the second common CN-to-BS DL tunnel, similar to the event 624. In turn, the CU 172 sends the 634 the MBS data to the DU 174 via the second common CU-to-DU DL tunnel, similar to the event 626. The DU 174 transmits (e.g., multicast or unicast) 636 the MBS data via the one or more logical channels to the UE 103 (i.e., the UE 103A and the UE 103B), similar to the event 628. The UE 103 receives 636 the MBS data via the one or more logical channels, similar to the event 628.

After the procedure 695, the CU 172 continues to receive 638 MBS data of the first MBS session from the CN 110 via the first common CN-to-BS DL tunnel and transmits 640 the MBS data to the DU 174 via the first common CU-to-DU DL tunnel. In some implementations, the DU 174 transmits 642 the MBS data to the UE 102A and UE 102B via multicast, similar to the event 628. The UE 102A and UE 102B can receive 642 MBS data similar to the event 628. Alternatively, the base station 104 can transmit the MBS data to the UE 102A and UE 102B separately via unicast, similar to the event 628. In this case, the UE 102A and UE 102B can receive 642 MBS data separately via unicast, similar to the event 628.

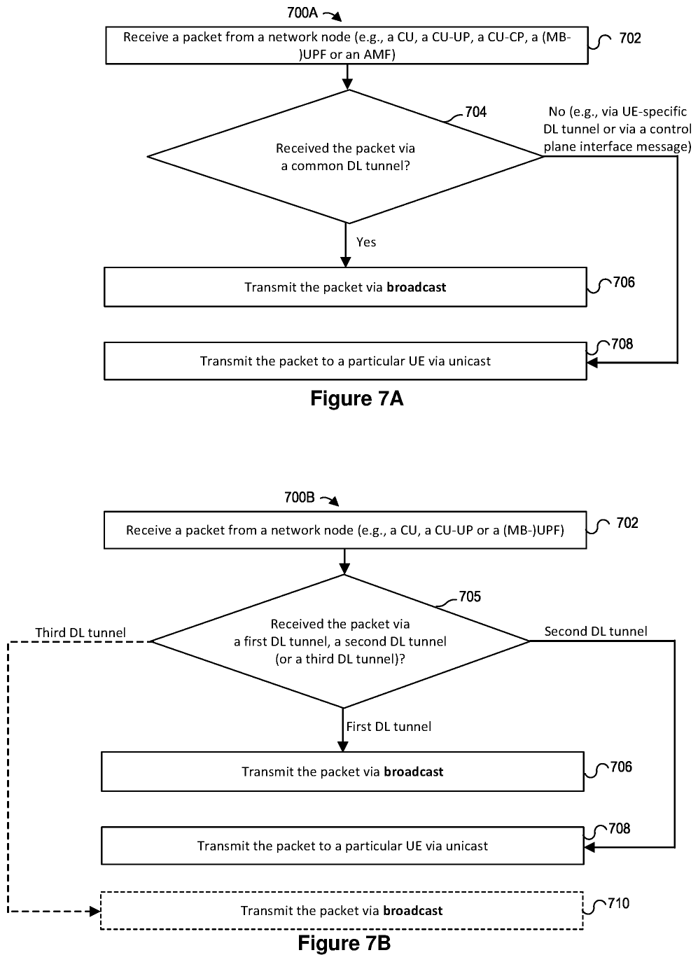

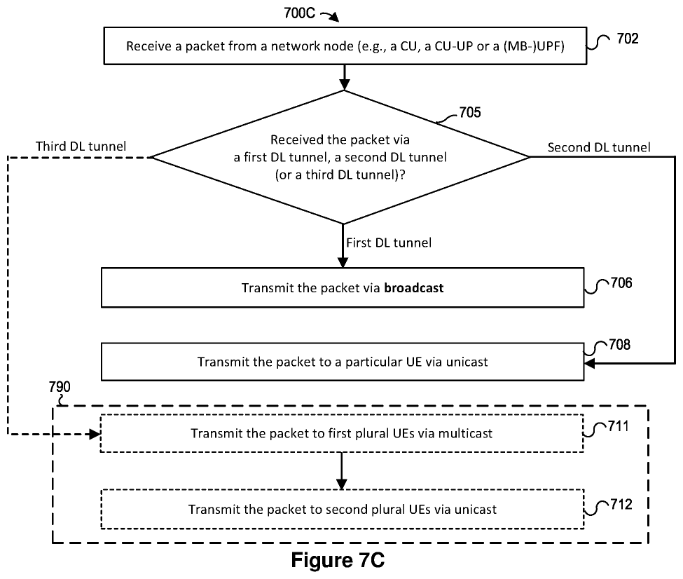

Referring first to FIG. 7A, a RAN node such as the DU 174 or base station 104 can implement a method 700A to determining to transmit a received packet via broadcast or unicast, based on whether the packet is received via a common DL tunnel. The method 700A begins at block 702, where the RAN node receives a packet from a network node (e.g., a CU, a CU-UP, a CU-CP, a (MB-) UPF or an AMF) (see e.g., events 502, 516, 518, 522, 528, 530, 602, 618, 624, 626, 630, 632, 634, 638, 640, 695). At block 704, the RAN node determines whether it received the packet via a common DL tunnel. When the RAN node received the packet via a common DL tunnel, the flow proceeds to block 706. At block 706, the RAN node transmits the packet via broadcast (see e.g., events 520, 532, 538). Otherwise, when the RAN node received the packet not via a common DL tunnel (e.g., the RAN node received the packet via UE-specific DL tunnel or via a control plane interface message), the flow proceeds to block 708. At block 708, the RAN node transmits the packet to a particular UE via unicast (see e.g., events 602, 620, 628, 630, 636, 642).

In some implementations, the packet can be an IP packet, an Ethernet packet or a user-plane (UP) packet. In such cases, the RAN node (e.g., base station 104) receives the packet from the UPF (e.g., UPF 162 or MB-UPF 162). In some implementations, the packet can be associated to an MBS session. In other implementations, the packet is not associated to a MBS session. In some implementations, the packet can be associated to a PDU session.

In other implementations, the packet can be a NAS PDU. In such cases, the RAN node (e.g., base station 104) receives the NAS PDU from the AMF (e.g., AMF 164).

In some implementations, the packet can be a PDCP PDU, the DU (e.g., DU 174) receives the PDCP PDU from the CU (e.g., CU 172). In cases where the PDCP PDU includes an IP packet, an Ethernet packet, MBS data packet or a user-plane (UP) packet, the DU can receive the PDCP PDU from the CU-UP (e.g., CU-UP 172B). In cases where the PDCP PDU includes an RRC message, the DU can receive the PDCP PDU from the CU-CP (e.g., CU-CP 172A).

In some implementations, the control plane interface message is an F1AP message or a W1AP message. In other implementations, the control plane interface message is a NGAP message or a S1AP message. In some implementations, the control plane interface message is a UE-associated message, i.e., the message is associated to the particular UE.

FIG. 7B is a flow diagram of an example method 700B, similar to the method 700A of FIG. 7A. The method 700B begins at block 702, where the RAN node receives a packet from a network node (e.g., a CU, a CU-UP or a (MB-)UPF) (see e.g., events 502, 516, 518, 522, 528, 530, 602, 624, 626, 630, 632, 634, 638, 640). At block 705, the RAN node determines whether it received the packet via a first DL tunnel, a second DL tunnel (or optionally a third DL tunnel). The flow proceeds to block 706, 708, or 710 (optional) when the RAN node determines that the packet is received via a first DL tunnel, a second DL tunnel, or a third DL tunnel, respectively. At block 706, the RAN node transmits the packet via broadcast (see e.g., events 520, 538). At block 708, the RAN node transmits the packet to a particular UE via unicast (see e.g., events 602, 620, 628, 630, 636, 642). At block 710, the RAN node transmits the packet via broadcast (see e.g., events 532).

FIG. 7C is a flow diagram of an example method 700C, similar to the method 700B of FIG. 7B. The method 700C begins at block 702, where the RAN node receives a packet from a network node (e.g., a CU, a CU-UP or a (MB-)UPF) (see e.g., events 502, 516, 518, 522, 528, 530, 602, 624, 626, 630, 632, 634, 638, 640). At block 704, the RAN node determines whether it receives the packet via a first DL tunnel, a second DL tunnel (or optionally a third DL tunnel). The flow proceeds to block 706, 708, or blocks 711 (optional) and 712 (optional) when the RAN node determines that the packet is received via a first DL tunnel, a second DL tunnel, or a third DL tunnel, respectively. When the RAN node received the packet via a first DL tunnel, the flow proceeds to block 706. At block 706, the RAN node transmits the packet via broadcast (see e.g., event 532). When the RAN node received the packet via a second DL tunnel, the flow proceeds to block 708. At block 708, the RAN node transmits the packet to a particular UE via unicast (see e.g., events 602, 620, 628, 630, 636, 642). When the RAN node received the packet via a third DL tunnel, the flow proceeds to block 711. At block 711, the RAN node can transmit the packet to first plural UEs via multicast (see e.g., events 628, 636, 642). At block 712, the RAN node can transmit the packet to second plural UEs via unicast (see e.g., events 628, 636, 642).

The blocks 711 and 712 are collectively referred to in FIG. 7C as an MBS data transmission procedure 790.

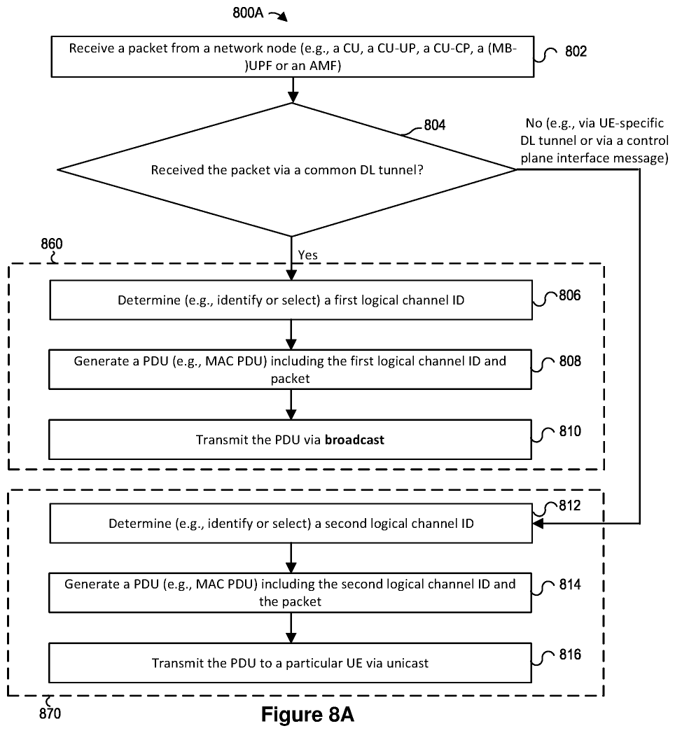

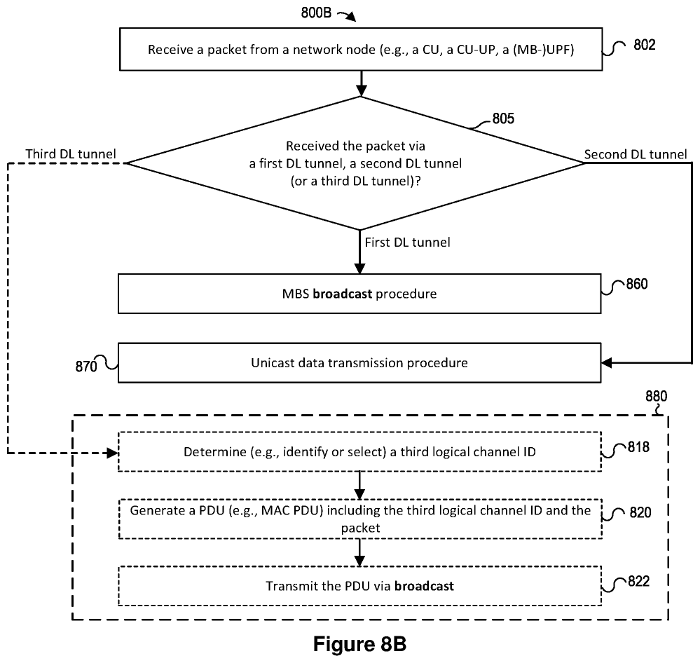

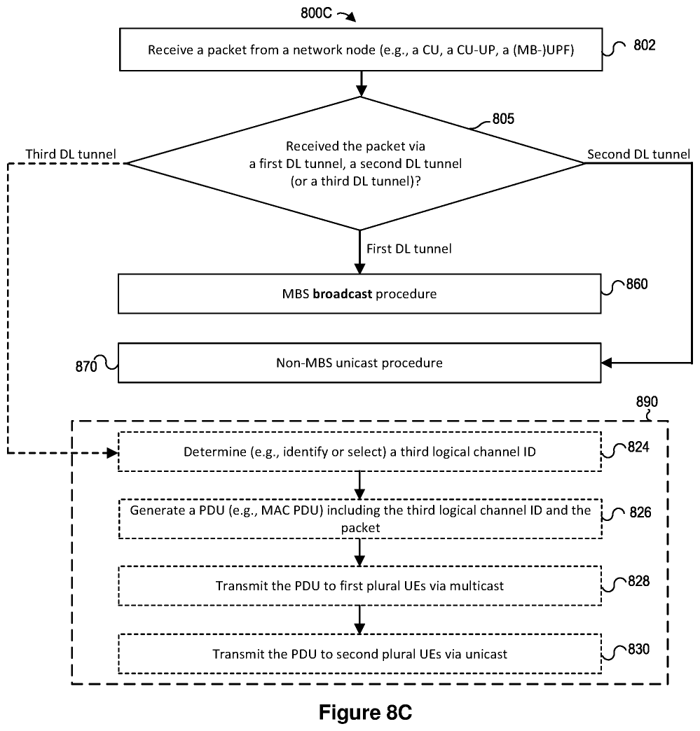

Now referring first to FIG. 8A, a RAN node such as the DU 174 or base station 104 can implement a method 800A to determining to transmit a received packet via broadcast or unicast, based on whether the packet is received via a common DL tunnel. The method 800A begins at block 802, where the RAN node receives a packet from a network node (e.g., a CU, a CU-UP, a CU-CP, a (MB-)UPF or an AMF) (see e.g., events 502, 516, 518, 522, 528, 530, 602, 618, 624, 626, 630, 632, 634, 638, 640, 695). At block 804, the RAN node determines whether it received the packet via a common DL tunnel. When the RAN node received the packet via a common DL tunnel, the flow proceeds to blocks 806, 808 and 810. At block 806, the RAN node determines (e.g., identify or select) a first logical channel ID. At block 808, the RAN node generates a PDU (e.g., MAC PDU) including the first logical channel ID and packet (see e.g., events 530, 532, 538). At block 810, the RAN node transmits the PDU via broadcast (see e.g., events 530, 532, 538). Otherwise, when the RAN node received the packet not via a common DL tunnel (e.g., the RAN node received the packet via UE-specific DL tunnel or via a control plane interface message), the flow proceeds to blocks 812, 814 and 814. At block 812, the RAN node determines (e.g., identify or select) a second logical channel ID. At block 814, the RAN node generates a PDU (e.g., MAC PDU) including the second logical channel ID and the packet (see e.g., events 602, 620, 628, 630, 636, 642). At block 816, the RAN node transmits the PDU to a particular UE via unicast (see e.g., events 602, 620, 628, 630, 636, 642).

The blocks 806, 808 and 810 are collectively referred to in FIG. 8A as an MBS broadcast procedure 860. The blocks 812, 814 and 816 are collectively referred to in FIG. 8A as a unicast data transmission procedure 870.

FIG. 8B is a flow diagram of an example method 800B, similar to the method 800A of FIG. 8A. The method 800B begins at block 802, where the RAN node receives a packet from a network node (e.g., a CU, a CU-UP, a (MB-)UPF) (see e.g., events 502, 516, 518, 528, 530, 602, 624, 626, 630, 632, 634, 638, 640). At block 804, the RAN node determines whether it receives the packet via a first DL tunnel, a second DL tunnel (or optionally a third DL tunnel). The flow proceeds to block 860, 870, or blocks 818, 820 and 822 (optional) when the RAN node that it received the packet via a first DL tunnel, a second DL tunnel, or a third DL tunnel, respectively. When the RAN node determines that it received the packet via a first DL tunnel, the flow proceeds to block 860. At block 860, the RAN node performs MBS broadcast procedure described for FIG. 8A (see e.g., events 520, 538). When the RAN node determines that it received the packet via a second DL tunnel, the flow proceeds to block 870. At block 870, the RAN node performs the unicast data transmission procedure described for FIG. 8A (see e.g., events 502, 522, 602, 628, 630, 636, 642). When the RAN node determines that it received the packet via a third DL tunnel, the flow proceeds to blocks 818, 820 and 822. At block 818, the RAN node determines (e.g., identify or select) a third logical channel ID. At block 820, the RAN node generates a PDU (e.g., MAC PDU) including the third logical channel ID and the packet (see e.g., event 532). At block 822, the RAN node transmits the PDU via broadcast (see e.g., event 532).

The blocks 818, 820 and 822 are collectively referred to in FIG. 8B as an MBS broadcast procedure 880.

FIG. 8C is a flow diagram of an example method 800C, similar to the method 800B of FIG. 8B. The method 800C begins at block 802, where the RAN node receives a packet from a network node (e.g., a CU, a CU-UP, a (MB-)UPF) (see e.g., events 502, 516, 518, 522, 528, 530, 602, 624, 626, 630, 632, 634, 638, 640). At block 804, the RAN node determines whether it received the packet via a first DL tunnel, a second DL tunnel (or optionally a third DL tunnel). The flow proceeds to block 860, 870, or blocks 824, 826, 828 and 830 (optional), when the RAN node determines to receive the packet via a first DL tunnel, a second DL tunnel, or a third DL tunnel, respectively. When the RAN node determines that it received the packet via a first DL tunnel, the flow proceeds to block 860. At block 860, the RAN node performs the MBS broadcast procedure described for FIG. 8A (see e.g., events 520, 538). When the RAN node determines that it received the packet via a second DL tunnel, the flow proceeds to block 870. At block 870, the RAN node performs the unicast data transmission procedure described for FIG. 8A (see e.g., events 502, 522, 602, 628, 630, 636, 642). When the RAN node determines that it received the packet via a third DL tunnel, the flow proceeds to blocks 824, 826, 828 and 830. At block 824, the RAN node determines (e.g., identify or select) a third logical channel ID. At block 826, the RAN node generates a PDU (e.g., MAC PDU) including the third logical channel ID and the packet. At block 828, the RAN node transmits the PDU to first plural UEs via multicast (see e.g., events 628, 636, 642). At block 830, the RAN node transmits the PDU to second plural UEs via unicast (see e.g., events 628, 636, 642).

The blocks 824, 826, 828 and 830 are collectively referred to in FIG. 8C as an MBS data transmission procedure 890.

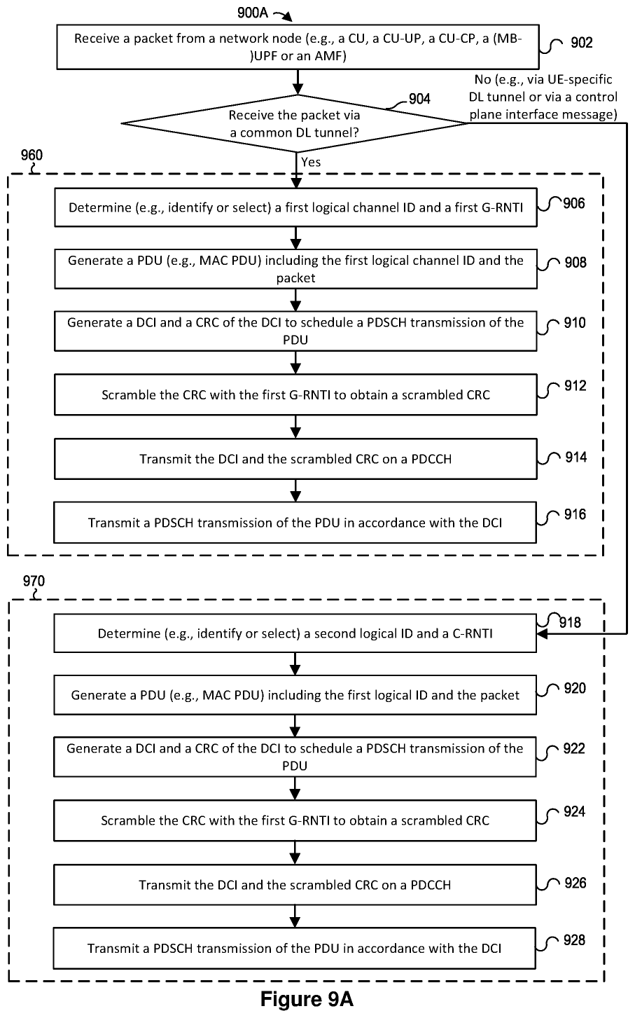

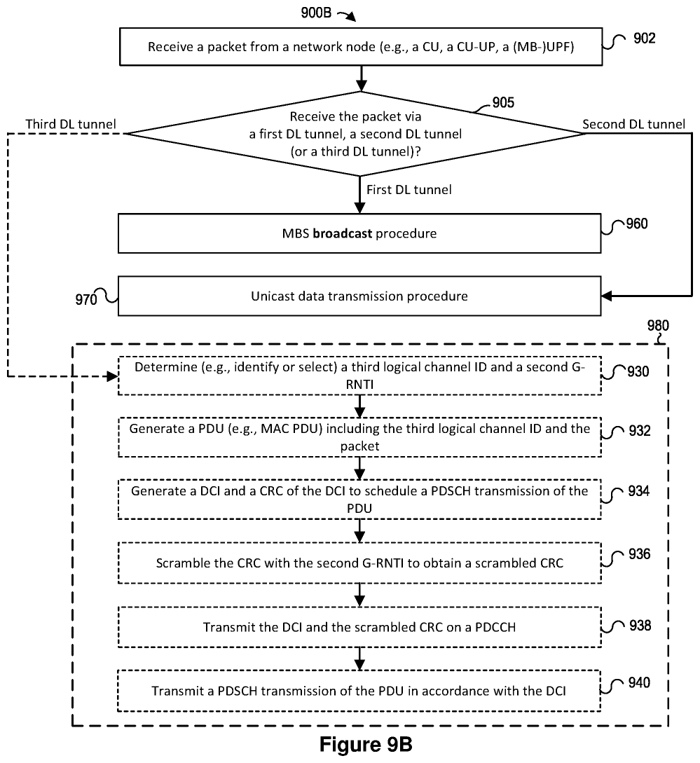

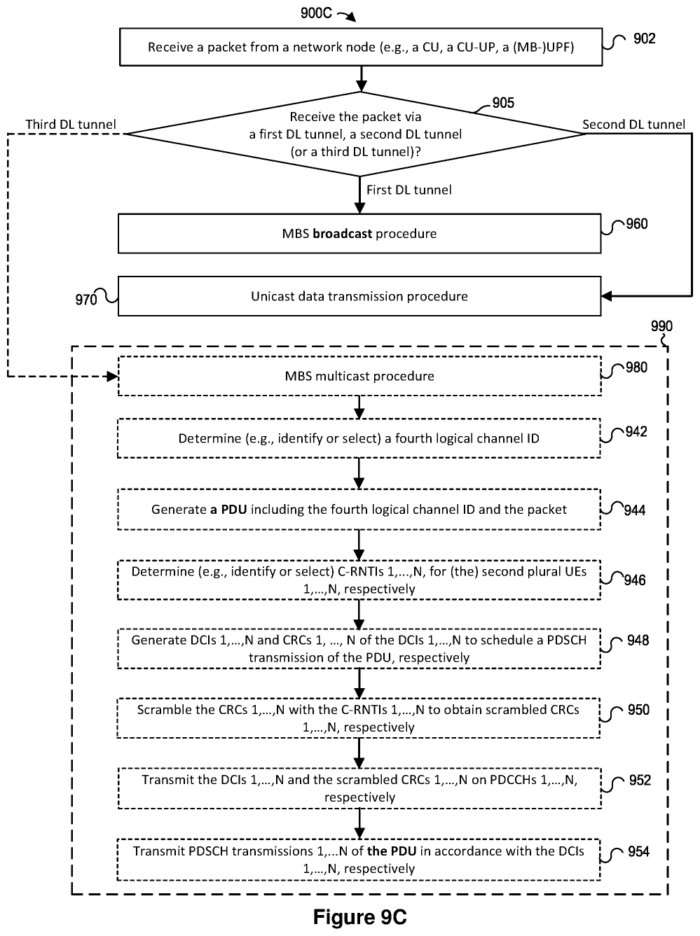

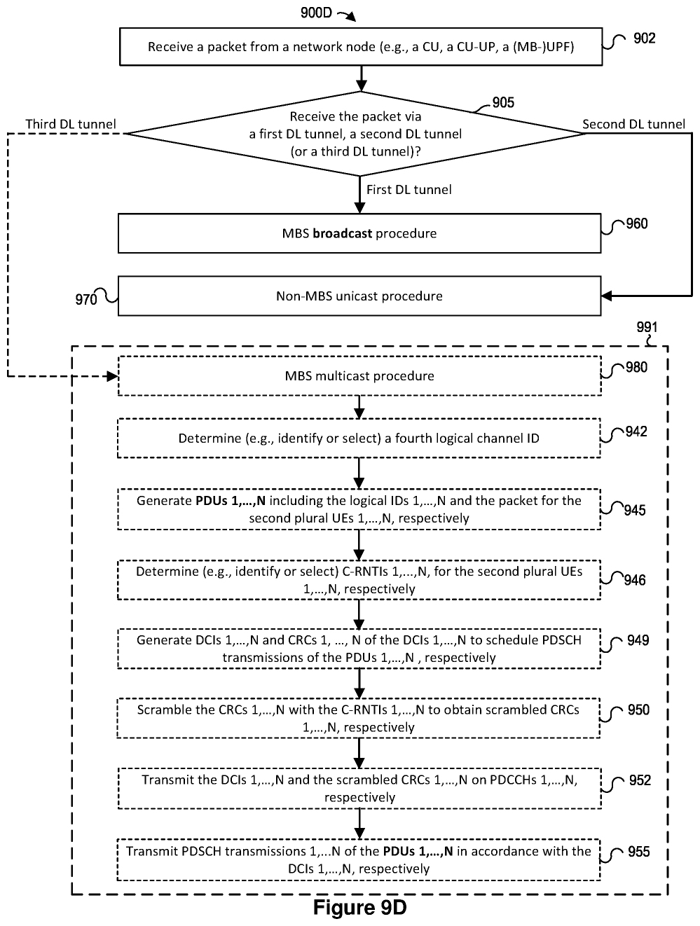

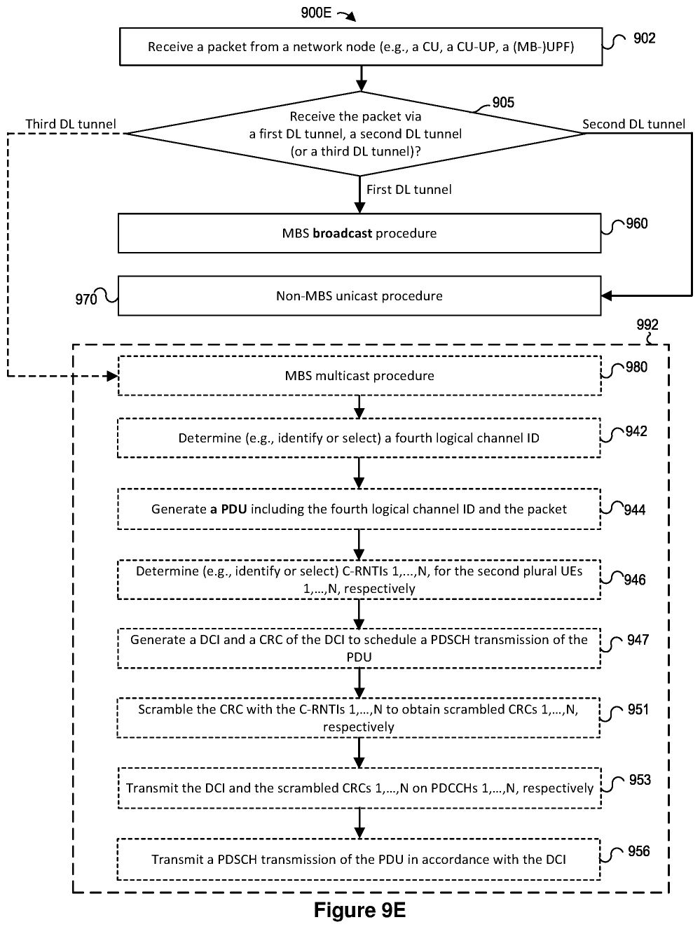

Now referring first to FIG. 9A, a RAN node such as the DU 174 or base station 104 can implement a method 900A to determining to transmit a received packet via broadcast or unicast, based on whether the packet is received via a common DL tunnel.

The method 900A begins at block 902, where the RAN node receives a packet from a network node (e.g., a CU, a CU-UP, a CU-CP, a (MB-)UPF or an AMF) (see e.g., events 502, 516, 518, 522, 528, 530, 602, 618, 624, 626, 630, 632, 634, 638, 640, 695). At block 904, the RAN node determines whether it received the packet via a common DL tunnel. When the RAN node determines that it received the packet via a common DL tunnel, the flow proceeds to blocks 906-916. At block 906, the RAN node determines (e.g., identify or select) a first logical channel ID and a first G-RNTI. At block 908, the RAN node generates a PDU (e.g., MAC PDU) including the first logical channel ID and the packet (see e.g., events 530, 532, 538). At block 910, the RAN node generates a DCI and a CRC of the DCI to schedule a PDSCH transmission of the PDU (see e.g., events 530, 532, 538). At block 912, the RAN node scrambles the CRC with the first G-RNTI to obtain a scrambled CRC (see e.g., events 530, 532, 538). At block 914, the RAN node transmits the DCI and the scrambled CRC on a PDCCH (see e.g., events 530, 532, 538). At block 916, the RAN node transmits a PDSCH transmission of the PDU in accordance with the DCI (see e.g., events 530, 532, 538). Otherwise, when the RAN node, at block 804, determines that it received the packet via a common DL tunnel (e.g., via UE-specific DL tunnel or via a control plane interface message), the flow proceeds to blocks 918-928. At block 918, the RAN node determines (e.g., identify or select) a second logical channel ID and a C-RNTI. At block 920, the RAN node generates a PDU (e.g., MAC PDU) including the first logical channel ID and the packet (see e.g., events 602, 620, 628, 630, 636, 642). At block 922, the RAN node generates a DCI and a CRC of the DCI to schedule a PDSCH transmission of the PDU (see e.g., events 602, 620, 628, 630, 636, 642). At block 924, the RAN node scrambles the CRC with the first G-RNTI to obtain a scrambled CRC (see e.g., events 602, 620, 628, 630, 636, 642). At block 926, the RAN node transmits the DCI and the scrambled CRC on a PDCCH (see e.g., events 602, 620, 628, 630, 636, 642). At block 928, the RAN node transmits a PDSCH transmission of the PDU in accordance with the DCI (see e.g., events 602, 620, 628, 630, 636, 642).

The blocks 906-916 are collectively referred to in FIG. 8A as an MBS broadcast procedure 960. The blocks 918-928 are collectively referred to in FIG. 9A a unicast data transmission procedure 970.

FIG. 9B is a flow diagram of an example method 900B, similar to the method 900A of FIG. 9A. The method 900B begins at block 902, where the RAN node receives a packet from a network node (e.g., a CU, a CU-UP, a (MB-)UPF) (see e.g., events 502, 516, 518, 522, 528, 530, 602, 624, 626, 630, 632, 634, 638, 640). At block 905, the RAN node determines whether it received the packet via a first DL tunnel, a second DL tunnel (or optionally a third DL tunnel). The flow proceeds to block 960, 970, or blocks 930-940 (optional) when the RAN node determines that it received the packet via a first DL tunnel, a second DL tunnel, or a third DL tunnel, respectively. When the RAN node determines that it received the packet via a first DL tunnel, the flow proceeds to block 960. At block 960, the RAN node performs the MBS broadcast procedure described for FIG. 9A (see e.g., events 520, 538). When the RAN node determines that it received the packet via a second DL tunnel, the flow proceeds to block 970. At block 970, the RAN node performs the unicast data transmission procedure described for FIG. 9A (see e.g., events 502, 522, 602, 628, 630, 636, 642). When the RAN node determines that it received the packet via a third DL tunnel, the flow proceeds to blocks 930-940. At block 930, the RAN node determines (e.g., identify or select) a third logical channel ID and a second G-RNTI. At block 932, the RAN node generates a PDU (e.g., MAC PDU) including the third logical channel ID and the packet (see e.g., event 532, 628, 636, 642). At block 934, the RAN node generates a DCI and a CRC of the DCI to schedule a PDSCH transmission of the PDU (see e.g., event 532). At block 936, the RAN node scrambles the CRC with the second G-RNTI to obtain a scrambled CRC (see e.g., event 532, 628, 636, 642). At block 938, the RAN node transmits the DCI and the scrambled CRC on a PDCCH (see e.g., event 532, 628, 636, 642). At block 940, the RAN node transmits a PDSCH transmission of the PDU in accordance with the DCI (see e.g., event 532, 628, 636, 642).

The blocks 930-940 are collectively referred to in FIG. 9B as an MBS broadcast procedure 980 or an MBS multicast procedure 980.

FIG. 9C is a flow diagram of an example method 900C, similar to the method 900B of FIG. 9B. The method 900C begins at block 902, where the RAN node receives a packet from a network node (e.g., a CU, a CU-UP, a (MB-)UPF) (see e.g., events 502, 516, 518, 522, 528, 530, 602, 624, 626, 630, 632, 634, 638, 640). At block 905, the RAN node determines whether it received the packet via a first DL tunnel, a second DL tunnel (or optionally a third DL tunnel). The flow proceeds to block 960, 970, or blocks 980 and 942-954 (optional), when the RAN node determines to receive the packet via a first DL tunnel, a second DL tunnel, or a third DL tunnel, respectively. When the RAN node determines that it received the packet via a first DL tunnel, the flow proceeds to block 960. At block 960, the RAN node performs the MBS broadcast procedure described for FIG. 8A (see e.g., events 520, 538). When the RAN node determines that it received the packet via a second DL tunnel, the flow proceeds to block 970. At block 970, the RAN node performs the unicast data transmission procedure described for FIG. 9A (see e.g., events 502, 522, 602, 628, 630, 636, 642). When the RAN node determines to receive the packet via a third DL tunnel, the flow proceeds to block 980. At block 980, the RAN node performs the MBS multicast procedure (see e.g., 628, 636, 642). At block 942, the RAN node determines (e.g., identify or select) a fourth logical channel ID (see e.g., events 602, 620, 628, 630, 636, 642). At block 944, the RAN node generates a PDU including the fourth logical channel ID and the packet (see e.g., events 602, 620, 628, 630, 636, 642). At block 946, the RAN node determines (e.g., identify or select)C-RNTIs 1, . . . , N, for (the) second plural UEs 1, . . . , N, respectively (see e.g., events 602, 620, 628, 630, 636, 642). At block 948, the RAN node generates DCIs 1, . . . , N and CRCs 1, . . . , N of the DCIs 1, . . . , N to schedule a PDSCH transmission of the PDU, respectively (see e.g., events 602, 620, 628, 630, 636, 642). At block 850, the RAN node scrambles the CRCs 1, . . . , N with the C-RNTIs 1, . . . , N to obtain scrambled CRCs 1, . . . , N, respectively (see e.g., events 602, 620, 628, 630, 636, 642). At block 952, the RAN node transmits the DCIs 1, . . . , N and the scrambled CRCs 1, . . . , N on PDCCHs 1, . . . , N, respectively (see e.g., events 602, 620, 628, 630, 636, 642). At block 954, the RAN node transmits PDSCH transmissions 1, . . . , N of the PDU in accordance with the DCIs 1, . . . , N, respectively (see e.g., events 602, 620, 628, 630, 636, 642).

The blocks 980 and 942, 944, 946, 948, 950, 952 and 954 are collectively referred to in FIG. 9C as an MBS data transmission procedure 990.

In some implementations, (a value of) the fourth logical ID is the same (a value) of the third logical channel ID. In such cases, the blocks 942 and 944 can be omitted. In some implementations, the RAN node can use the DCI generated at block 980 to unicast the PDU to the second plural UEs. In such cases, the RAN node can omit the block 947.

FIG. 9D is a flow diagram of an example method 900D, similar to the method 900C of FIG. 9C, except that method 900D includes blocks 945, 949 and 955 instead of blocks 944, 948 and 954. At block 945, the RAN node generates PDUs 1, . . . , N including the logical channel IDs 1, . . . , N and the packet for the second plural UEs 1, . . . , N, respectively (see e.g., events 602, 620, 628, 630, 636, 642). At block 949, the RAN node generates DCIs 1, . . . , N and CRCs 1, . . . , N of the DCIs 1, . . . , N to schedule PDSCH transmissions of the PDUs 1, . . . , N, respectively (see e.g., events 602, 620, 628, 630, 636, 642). At block 955, the RAN node transmits PDSCH transmissions 1, . . . , N of the PDUs 1, . . . , N in accordance with the DCIs 1, . . . , N, respectively (see e.g., events 602, 620, 628, 630, 636, 642).

The blocks 980 and 942, 945, 946, 949, 950, 952 and 955 are collectively referred to in FIG. 9D as an MBS data transmission procedure 991.

FIG. 9E is a flow diagram of an example method 900E, similar to the methods 900C of FIG. 9C and FIG. 900D of FIG. 9D, except that method 900E includes blocks 947, 951 and 956 instead of blocks 948, 952, 954. At block 947, the RAN node generates a DCI and a CRC of the DCI to schedule a PDSCH transmission of the PDU (see e.g., events 602, 620, 628, 630, 636, 642). At block 951, the RAN node scrambles the CRC with the C-RNTIs 1, . . . , N to obtain scrambled CRCs 1, . . . , N, respectively (see e.g., events 602, 620, 628, 630, 636, 642). At block 953, the RAN node transmits the DCI and the scrambled CRCs 1, . . . , N on PDCCHs 1, . . . , N, respectively. At block 956, the RAN node transmits a PDSCH transmission of the PDU in accordance with the DCI (see e.g., events 602, 620, 628, 630, 636, 642).

The blocks 980 and 942, 944, 946, 947, 951, 953 and 956 are collectively referred to in FIG. 9D as an MBS data transmission procedure 992.

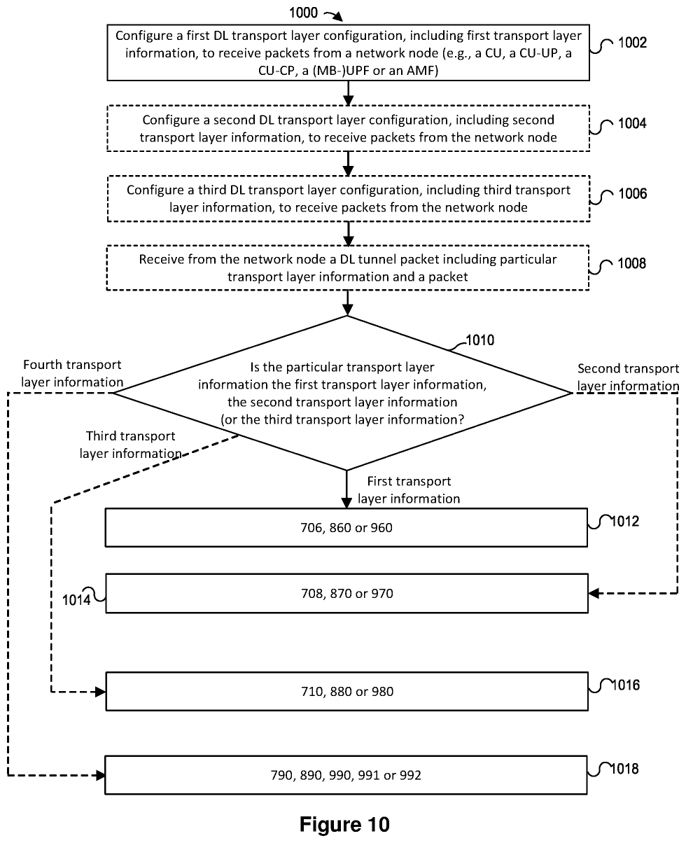

Referring first to FIG. 10, a RAN node such as the DU 174 or base station 104 can implement a method 1000 to determining to transmit a received packet via broadcast, unicast or multicast, based on whether the packet is received via a particular DL tunnel. The method 1000 begins at block 1002, where the RAN node can configure a first DL transport layer configuration, including first transport layer information, to receive packets from a network node (e.g., a CU, a CU-UP, a CU-CP, a (MB-)UPF or an AMF) (see e.g., events 508, 510, 591, 606, 619, 596). At block 1004, the RAN node can configure a second DL transport layer configuration, including second transport layer information, to receive packets from the network node (see e.g., events 508, 510, 591, 606, 619, 596). At block 1006, the RAN node can configure a third DL transport layer configuration, including third transport layer information, to receive packets from the network node (see e.g., events 508, 510, 591, 606, 619, 596). At block 1008, the RAN node receives from the network node a DL tunnel packet including particular transport layer information and a packet (see e.g., events 502, 516, 518, 522, 528, 530, 602, 618, 624, 626, 630, 632, 634, 638, 640, 695).

At block 1010, the RAN node determines whether the particular transport layer information is the first transport layer information, the second transport layer information (or the third transport layer information. The flow proceeds to block 1012, 1014, 1016, or 1018 when the RAN node determines the particular transport layer information is the first transport layer information, the second transport layer information, the third transport layer information, or the fourth transport layer information, respectively. When the RAN node determines the particular transport layer information is the first transport layer information, the flow proceeds to block 1012. At block 1012, the RAN node performs the MBS broadcast procedure in the block 706, 860 or 960. When the RAN node determines the particular transport layer information is the second transport layer information, the flow proceeds to block 1014. At block 914, the RAN node performs the unicast data transmission procedure 708, 870, or 970. When the RAN node determines the particular transport layer information is the third transport layer information, the flow proceeds to block 1016. At block 1016, the RAN node performs the MBS broadcast procedure 710, 880 or 980 procedures. When the RAN node determines the particular transport layer information is the fourth transport layer information, the flow proceeds to block 1018. At block 1018, the RAN node performs the MBS data transmission procedure 790, 890, 990, 991 or 992s.

In some implementations, the first transport layer information includes a first transport layer address (e.g., an IP address) and/or a first DL tunnel ID (e.g., GTP-U tunnel ID). In some implementations, the second transport layer information includes a second transport layer address (e.g., an IP address) and/or a second DL tunnel ID (e.g., GTP-U tunnel ID). In some implementations, the third transport layer information includes a third transport layer address (e.g., an IP address) and/or a third DL tunnel ID (e.g., GTP-U tunnel ID). In some implementations, the fourth transport layer information includes a fourth transport layer address (e.g., an IP address) and/or a fourth DL tunnel ID (e.g., GTP-U tunnel ID).

In some implementations, the first, second, third and fourth transport layer information are different. For example, the first transport layer address and/or the first tunnel ID can be different from the second transport layer address and/or second tunnel ID. In cases where the first and second transport layer addresses are the same, the first and second tunnel IDs are different. In cases where the first and second tunnel IDs are the same, the first and second transport layer addresses are different.

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the techniques of this disclosure can be implemented (e.g., the UE 102 or 103) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for communicating MBS information through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method in a node of a Radio Access Network (RAN) for delivering data to User Equipments (UEs), the method comprising:
receiving, by a Distributed Unit (DU) of a distributed base station of the RAN and from a network node, a packet including data that is to be delivered from a Core Network (CN) to one or more User Equipments (UEs);
when the DU received the packet from the network node via a common downlink (DL) tunnel, transmitting, by the DU the packet to at least some of the one or more UEs via a broadcast transmission; and
when the DU did not receive the packet from the network node via the common DL tunnel, transmitting, by the DU, the packet to a particular UE of the one or more UEs via a unicast transmission.

2. The method of claim 1, wherein:
the packet is an IP packet, an Ethernet packet, or a user-plane packet, and receiving the packet from the network node includes receiving the packet from a user plane function; or
the packet is a non-access stratum protocol data unit, and receiving the packet from the network node includes receiving the packet from an access and mobility management function.

3. The method of claim 1, wherein the packet is associated with a session of a Multicast and/or Broadcast Services (MBS) service or the packet is associated with a session of a Protocol Data Unit (PDU).

4. (canceled)

5. (canceled)

6. The method of claim 1, wherein:
the network node is a Central Unit (CU) of the distributed base station;
the packet is an IP packet, an Ethernet packet, a packet including data of a Multicast and/or Broadcast Services (MBS) service, or a user-plane packet; and
receiving the packet from the network node includes receiving the packet from a user plane of the CU.

7. (canceled)

8. The method of claim 1, wherein receiving the packet from the network node includes receiving a packet via a control plane interface message, and wherein the control plane interface message is an F1AP message, a W1AP message, an NGAP message, an S1AP message, or a message associated with the particular UE.

9. (canceled)

10. The method of claim 1, wherein the common DL tunnel is associated with a session of a Multicast and/or Broadcast Services (MBS) service.

11. The method of claim 10, wherein receiving the packet from the network node includes receiving the packet from the network node via another DL tunnel that is specific to only the particular UE.

12. The method of claim 11, wherein the packet includes data provided by the MBS service, and the another DL tunnel is associated with the session of the MBS service.

13. The method of claim 10, wherein the packet is a first packet, the at least some of the one or more UEs is a first subset of a plurality of UEs, the common DL tunnel is a first common DL tunnel, the MBS service is a first MBS service, the session is a first session of the first MBS service, the broadcast transmission is a first broadcast transmission, and the method further comprises:
receiving, by the DU, a second packet from the network node via a second common DL tunnel associated with a second session of the first MBS service or a session of a second MBS service; and
based on the reception of the second packet via the second common DL tunnel, causing, by the DU, the second packet to be transmitted to a second subset of the plurality of UEs via a second broadcast transmission.

14. The method of claim 10, wherein the packet is a first packet, the at least some of the one or more UEs is a first subset of a plurality of UEs, the common DL tunnel is a first common DL tunnel, the MBS service is a first MBS service, the session is a first session of the first MBS service, and the method further comprises:
receiving, by the DU, a third packet from the network node via a third common DL tunnel associated with a third session of the first MBS service or a session of a third MBS service; and
based on the reception of the third packet via the third common DL tunnel, causing, by the DU, the third packet to be transmitted to a third subset of the plurality of UEs via a multicast transmission.

15. The method of claim 10, wherein the common DL tunnel has another endpoint at the DU.

16. A method in a node of a Radio Access Network (RAN) for delivering data to User Equipments (UEs), the method comprising:
receiving, by a Distributed Unit (DU) of a distributed base station of the RAN, a packet from a network node via a particular downlink (DL) tunnel of a plurality of DL tunnels, the packet including data that is to be delivered from a Core Network (CN) to one or more User Equipments (UEs);
when the particular tunnel is a first DL tunnel included in the plurality of DL tunnels, transmitting, by the DU, the packet to the one or more UEs via a broadcast transmission; and
when the particular tunnel is a second DL tunnel included in the plurality of DL tunnels, transmitting, by the DU, the packet to a particular UE of the one or more UEs via a unicast transmission.

17. The method of claim 16, wherein the one or more UEs includes a plurality of UEs, and the method further comprises, when the particular tunnel is a third tunnel included in the plurality of DL tunnels:
transmitting, by the DU, the packet to a first subset of the plurality of UEs via a respective broadcast transmission; and
transmitting, by the DU, the packet to a second subset of the plurality of UEs via respective unicast transmissions.

18. The method of claim 16, wherein the method further comprises, when the particular tunnel is a fourth tunnel included in the plurality of DL tunnels:
transmitting, by the DU, the packet to the one or more UEs via a multicast transmission.

19. The method of claim 16, wherein;
the packet is an IP packet, an Ethernet packet, or a user-plane packet, and receiving the packet from the network node includes receiving the packet from a user plane function; or
the packet is a non-access stratum protocol data unit, and receiving the packet from the network node includes receiving the packet from an access and mobility management function.

20. The method of claim 16, wherein the packet is associated with a session of a Multicast and/or Broadcast Services (MBS) service or the packet is associated with a session of a Protocol Data Unit (PDU).

21. (canceled)

22. (canceled)

23. The method of claim 16, wherein:
the network node is a Central Unit (CU) of the distributed base station;
the packet is an IP packet, an Ethernet packet, a packet including data of a Multicast and/or Broadcast Services (MBS) service, or a user-plane packet; and
receiving the packet from the network node includes receiving the packet from a user plane of the CU.

24. (canceled)

25. The method of claim 16, wherein the packet is a first packet and the method further comprises:
receiving, by the DU, a second packet from the network node via a control plane interface message, the second packet including a radio resource control message, an F1AP message, a W1AP message, a NGAP message, an S1AP message, or a message associated with the particular UE; and
transmitting the second packet to a respective particular UE via another unicast transmission based on the reception of the second packet via the control plane interface message.

26. (canceled)

27. The method of claim 16, wherein at least one of:
the one or more UEs includes a plurality of UEs and the second DL tunnel is specific to only the particular UE; or
the first DL tunnel is associated with a session of a Multicast and/or Broadcast Services (MBS) service and the packet includes data provided by the MBS service.

28. (canceled)

29. The method of claim 17, wherein the each DL tunnel has a respective other endpoint at the DU.

30. (canceled)

31. (canceled)
